(19) United States
(12) Patent Application Publication
(10) Pub. No.: US 2024/0214553 A1
(43) Pub. Date: Jun. 27, 2024

(54) SPATIAL LOCAL ILLUMINATION COMPENSATION

(71) Applicant: InterDigital CE Patent Holdings, SAS, PARIS (FR)

(72) Inventors: Ya Chen, Rennes (FR); Philippe Bordes, Laille (FR); Fabrice Le Léannec, Betton (FR); Antoine Robert, Mezieres sur Couesnon (FR)

(21) Appl. No.: 18/276,302

(22) PCT Filed: Jan. 27, 2022
(86) PCT No.: PCT/EP2022/051924

§ 371 Date: Aug. 8, 2023

(30) Foreign Application Priority Data
Feb. 8, 2021 (EP) 21305170.9

(51) Int. Cl. H04N 19/105; G06T 5/20; G06T 5/94; H04N 19/167; H04N 19/196; H04N 19/52

(52) U.S. Cl. CPC H04N 19/105; G06T 5/20; G06T 5/94; H04N 19/167; H04N 19/196; H04N 19/52; G06T 2207/10016

(57) ABSTRACT

At least a method and an apparatus are presented for efficiently encoding or decoding video. For example, parameters for a local illumination compensation LIC of a current block being encoded/decoded in a picture are determined based on spatially neighboring reconstructed samples and corresponding spatially neighboring reconstructed samples of at least one spatial reference block, wherein the at least one spatial reference block is a spatially neighboring block of the current block in the picture. For example, a flag enables/disables the spatial LIC for the current block. For example, the spatial LIC is applied to any of an Inter/Intra/IBC prediction. For example, multiple spatial reference blocks are used in determining the spatial LIC parameters. For example, spatially neighboring reconstructed samples of multiple lines are used in determining the spatial/temporal LIC parameters.

### TECHNICAL FIELD

At least one of the present embodiments generally relates to a method or an apparatus for video encoding or decoding, and more particularly, to a method or an apparatus comprising applying a spatial local illumination compensation.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction. Recent additions to video compression technology include various industry standards, versions of the reference software and/or documentations such as Joint Exploration Model (JEM) and later VTM (Versatile Video Coding (VVC) Test Model) being developed by the JVET (Joint Video Exploration Team) group. The aim is to make further improvements to the existing HEVC (High Efficiency Video Coding) standard.

Existing methods for coding and decoding show some limitations in compensating illumination discrepancy between different regions/blocks in the same slice/picture. The issue is particularly salient for content comprising some sample values with gradually propagating spatial illumination variation in inter/intra/IBC prediction. Therefore, there is a need to improve the state of the art.

### SUMMARY

The drawbacks and disadvantages of the prior art are solved and addressed by the general aspects described herein.

According to a first aspect, there is provided a method. The method comprises video decoding by determining, for a current block being decoded in a picture, parameters for a local illumination compensation based on spatially neighboring reconstructed samples and corresponding spatially neighboring reconstructed samples of at least one spatial reference block; decoding the current block using local illumination compensation based on the determined parameters. Advantageously, the at least one spatial reference block is a spatially neighboring block of the current block in the picture.

According to another aspect, there is provided a second method. The method comprises video encoding by determining, for a current block being encoded in a picture, parameters for a local illumination compensation based on spatially neighboring reconstructed samples of the current block and corresponding spatially neighboring reconstructed samples of at least one spatial reference block; encoding the current block using local illumination compensation based on the determined parameters Advantageously, the at least one spatial reference block is a spatially neighboring block of the current block in the picture.

According to another aspect, there is provided an apparatus. The apparatus comprises one or more processors, wherein the one or more processors are configured to implement the method for video decoding according to any of its variants. According to another aspect, the apparatus for video decoding comprises means for determining, for a current block being decoded in a picture, parameters for a local illumination compensation based on spatially neighboring reconstructed samples and corresponding spatially neighboring reconstructed samples of at least one spatial reference block; means for decoding the current block using local illumination compensation based on the determined parameters. Advantageously, the at least one spatial reference block is a spatially neighboring block of the current block in the picture.

According to another aspect, there is provided another apparatus. The apparatus comprises one or more processors, wherein the one or more processors are configured to implement the method for video encoding according to any of its variants. According to another aspect, the apparatus for video encoding comprises means for determining, for a current block being encoded in a picture, parameters for a local illumination compensation based on spatially neighboring reconstructed samples and corresponding spatially neighboring reconstructed samples of at least one spatial reference block; means for encoding the current block using local illumination compensation based on the determined parameters. Advantageously, the at least one spatial reference block is a spatially neighboring block of the current block in the picture.

According to another general aspect of at least one embodiment, a syntax element is determined that indicates whether the spatial local illumination compensation applies on the current block or not.

According to another general aspect of at least one embodiment, the current block is coded in any of an inter prediction, intra prediction, IBC prediction.

According to another general aspect of at least one embodiment, the at least one spatial reference block is any of above neighboring block and left neighboring block.

According to another general aspect of at least one embodiment, the at least one spatial reference block is any of above neighboring block (B0), left neighboring block (A0), above-right neighboring block (B1), bottom-left neighboring block (A1) and above-left neighboring block (B2).

According to another general aspect of at least one embodiment, a syntax element is determined that indicates which spatial reference block is used in determining the parameters of the local illumination compensation.

According to another general aspect of at least one embodiment, the at least one spatial reference block is a neighboring block selected as motion vector predictor MVP candidate in Inter prediction.

According to another general aspect of at least one embodiment, the at least one spatial reference block is responsive to an intra prediction mode used to code the current block.

According to another general aspect of at least one embodiment, the at least one spatial reference block comprises the neighboring block selected as intra block copy reference block.

According to another general aspect of at least one embodiment, the neighboring reconstructed samples are located in the left and above boundaries of the current block and at least one spatial reference block.

According to another general aspect of at least one embodiment, the neighboring reconstructed samples are located in the multi left and above reference lines of the current block and at least one spatial reference block. According to another general aspect of at least one embodiment, the neighboring reconstructed samples are located in the whole reconstructed blocks of the current block and at least one spatial reference block. According to another general aspect of at least one embodiment, the at least one spatial reference block comprises a first spatial reference block and a second spatial reference block and wherein the spatially neighboring reconstructed samples of the first spatial reference block and the spatially neighboring reconstructed samples of the second spatial reference block are averaged to determine the parameters of the local illumination compensation.

According to another aspect, there is provided a third method. The method comprises video decoding by determining, for a current block being decoded in a picture, parameters for a local illumination compensation based on spatially neighboring reconstructed samples and corresponding spatially neighboring reconstructed samples of at least one reference block; decoding the current block using local illumination compensation based on the determined parameters; wherein the neighboring reconstructed samples are located in the multi left and above reference lines of the current block and at least one reference block. According to another general aspect of at least one embodiment, the neighboring reconstructed samples are located in the whole reconstructed blocks of the current block and at least one spatial reference block

According to another aspect, there is provided a fourth method. The method comprises video encoding by determining, for a current block being encoded in a picture, parameters for a local illumination compensation based on spatially neighboring reconstructed samples and corresponding spatially neighboring reconstructed samples of at least one reference block; encoding the current block using local illumination compensation based on the determined parameters; wherein the neighboring reconstructed samples are located in the multi left and above reference lines of the current block and at least one reference block. According to another general aspect of at least one embodiment, the neighboring reconstructed samples are located in the whole reconstructed blocks of the current block and at least one spatial reference block

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates Coding Tree Unit (CTU) and Coding Unit (CU) concepts to represent a compressed VVC picture.

FIG. 2 illustrates the derivation of Local Illumination Compensation LIC parameters process with corresponding templates according to at least one embodiment.

FIG. 3 illustrates exemplary video game pictures with light sources creating a gradual illumination variation inside in a same picture.

FIG. 4 illustrates a generic encoding method according to a general aspect of at least one embodiment.

FIG. 5 illustrates a generic decoding method according to a general aspect of at least one embodiment.

FIG. 6 illustrates the deriving of spatial LIC parameters process with reference template of the above/left neighboring block for inter prediction according to at least one embodiment.

FIG. 7 illustrates a decoding method according to a first embodiment where spatial LIC is applied during the decoding of an inter block.

FIG. 8 illustrates the deriving of spatial LIC parameters process with an average reference template of the above and left neighboring block for inter prediction according to at least one embodiment.

FIG. 9 illustrates the positions of the spatial MVP candidates for an inter block.

FIG. 10 illustrates the deriving of spatial LIC parameters process with reference template of the above-right neighboring block for inter prediction according to at least one embodiment.

FIG. 11 illustrates a decoding method according to a second embodiment where spatial LIC is applied during the decoding of an inter block based on MVP candidates.

FIG. 12 illustrates the intra prediction directions in VVC.

FIG. 13 illustrates the deriving of spatial LIC parameters process with reference template of the above/left/above-right/bottom-left/above-left neighboring block for intra prediction according to at least one embodiment.

FIG. 14 illustrates the matrix weighted intra prediction process in VVC.

FIG. 15 illustrates a decoding method according to a third embodiment where spatial LIC is applied during the decoding of an intra block.

FIG. 16 illustrates the deriving of spatial LIC parameters process with reference template comprising the left boundary of a left neighboring block for intra prediction and with reference template comprising the above boundary of an above neighboring block for intra prediction according to at least one embodiment.

FIG. 17, 18 illustrate the deriving of spatial LIC parameters process with multiple lines reference template of a spatial neighboring block according to at least one embodiment.

FIG. 19 illustrates the deriving of spatial LIC parameters process with reference template comprising a spatial neighboring block according to at least one embodiment.

FIG. 20 illustrates the IBC prediction in VVC.

FIG. 21 illustrates the deriving of spatial LIC parameters process with reference template indicated by block vector for IBC prediction according to at least one embodiment.

FIG. 22 illustrates a decoding method according to a fourth embodiment where spatial LIC is applied during the decoding of an IBC block.

FIG. 23 illustrates a block diagram of an embodiment of video encoder in which various aspects of the embodiments may be implemented.

FIG. 24 illustrates a block diagram of an embodiment of video decoder in which various aspects of the embodiments may be implemented.

FIG. 25 illustrates a block diagram of an example apparatus in which various aspects of the embodiments may be implemented.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of an image. They may be applied to encode/decode a part of image, such as a slice or a tile, a tile group or a whole sequence of images.

Various methods are described above, and each of the methods comprises one or more steps or actions for achieving the described method. Unless a specific order of steps or actions is required for proper operation of the method, the order and/or use of specific steps and/or actions may be modified or combined.

At least some embodiments relate to method for encoding or decoding a video wherein a spatial LIC allows to compensate for gradual illumination in a same picture.

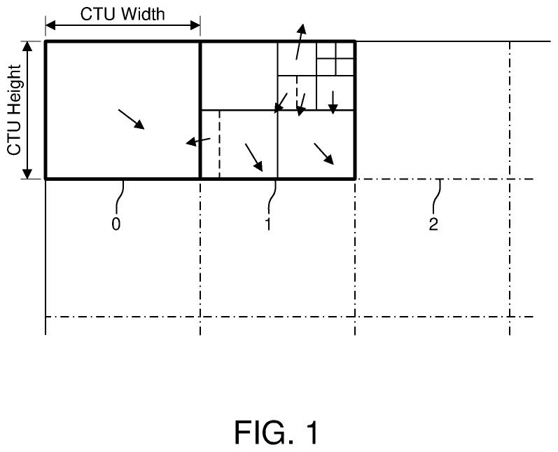

FIG. 1 illustrates Coding Tree Unit (CTU) and Coding Unit (CU) concepts to represent a compressed VVC picture. In VVC, a picture is divided into so-called Coding Tree Units (CTU), and each CTU is represented by one or more Coding Units (CUs). For each CU, spatial prediction (or “intra prediction”) and/or temporal prediction (also referred to as “inter prediction” or “motion compensated prediction”) are performed. Spatial prediction uses pixels from the samples of already coded neighboring blocks (which are called reference samples) in the same video picture/slice to predict the current video block. Spatial prediction reduces spatial redundancy inherent in the video signal. Temporal prediction uses reconstructed pixels from the already coded video pictures to predict the current video block. Temporal prediction reduces temporal redundancy inherent in the video signal. Temporal prediction signal for a given video block is usually signaled by one or more motion vectors which indicate the amount and the direction of motion between the current block and its reference block. Also, if multiple reference pictures are supported, then for each video block, its reference picture index is sent additionally; and the reference index is used to identify from which reference picture in the reference picture store the temporal prediction signal comes. After spatial and/or temporal prediction, the mode decision block in the encoder chooses the best prediction mode, for example based on the rate-distortion optimization method. For easier reference, we will be using the terms “CU” and “block” interchangeably throughout the current description.

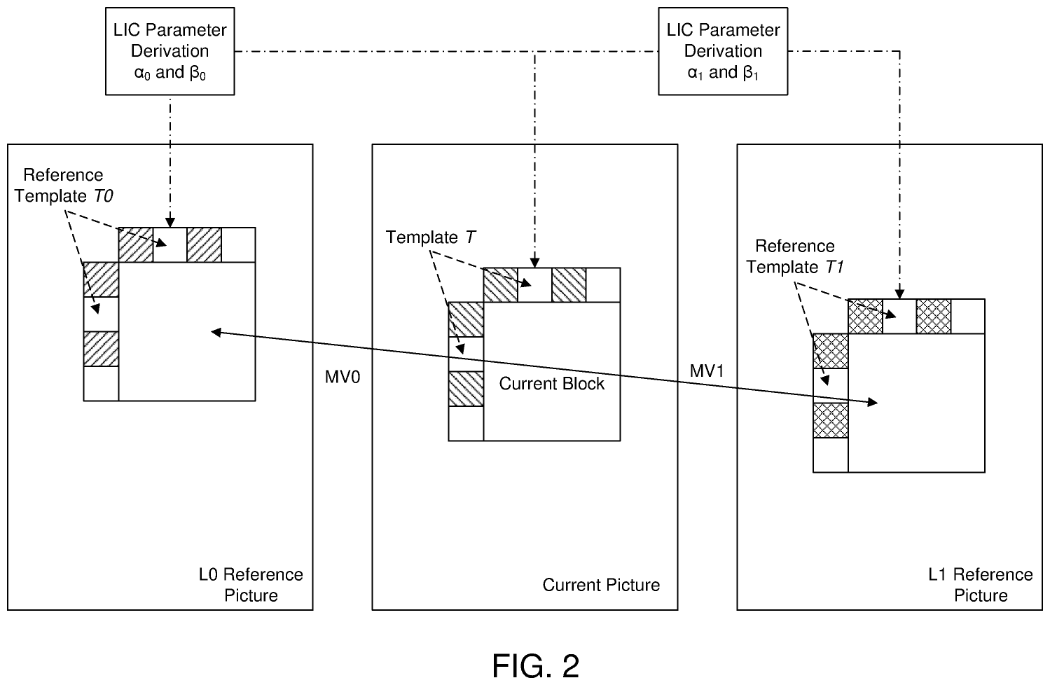

FIG. 2 illustrates the derivation of Local Illumination Compensation (LIC) parameters process with corresponding templates according to at least one embodiment. In temporal prediction process, LIC is a coding tool which is used to address the issue of local illumination changes that exist between temporal neighboring pictures. The LIC is based on a linear model where a scaling factor α and an offset β are applied to the reference samples to obtain the prediction samples of a current block. Specifically, the LIC is mathematically modelled by the following equation:

$$P ( x , y ) = α \cdot {P}_{r} ( x + {v}_{x} , y + {v}_{y} ) + β \qquad ( 1 )$$

where P(x,y) is the prediction signal of the current block at the coordinate (x,y); Pᵣ(x+vₓ,y+v_{y}) is the reference block pointed by the motion vector (vₓ,v_{y}); α and β are the corresponding scaling factor and offset that are applied to the reference block.

As shown in FIG. 2, when the LIC is applied for a block, a least mean square error (LMSE) method is employed to derive the values of the LIC parameters (i.e., α and β) by minimizing the difference between the neighbouring samples of the current block (i.e., the template T in FIG. 2) and their corresponding reference samples in the temporal reference pictures (i.e., either T₀ or T₁ in FIG. 2):

$${α}_{0 / 1} = \frac{N \cdot {\sum }_{i = 1}^{N} ( T ( {x}_{i} , {y}_{i} ) \cdot {T}_{0 / 1} ( {x}_{i} + {v}_{x}^{0 / 1} , {y}_{i} + {v}_{y}^{0 / 1} ) ) - {\sum }_{i = 1}^{N} ( T ( {x}_{i} , {y}_{i} ) ) \cdot {\sum }_{i = 1}^{N} ( {T}_{0 / 1} ( {x}_{i} + {v}_{x}^{0 / 1} , {y}_{i} + {v}_{y}^{0 / 1} ) )}{N \cdot {\sum }_{i = 1}^{N} ( {T}_{0 / 1} ( {x}_{i} + {v}_{x}^{0 / 1} , {y}_{i} + {v}_{y}^{0 / 1} ) \cdot {T}_{0 / 1} ( {x}_{i} + {v}_{x}^{0 / 1} , {y}_{i} + {v}_{y}^{0 / 1} ) ) - {( {\sum }_{i = 1}^{N} {T}_{0 / 1} ( {x}_{i} + {v}_{x}^{0 / 1} , {y}_{i} + {v}_{y}^{0 / 1} ) )}^{2}} \qquad ( 2 )$$

$${β}_{0 / 1} = \frac{{\sum }_{i = 1}^{N} ( T ( {x}_{i} , {y}_{i} ) ) - {α}_{0 / 1} \cdot {\sum }_{i = 1}^{N} ( {T}_{0 / 1} ( {x}_{i} + {v}_{x}^{0 / 1} , {y}_{i} + {v}_{y}^{0 / 1} ) )}{N} \qquad ( 3 )$$

where N represents the number of template samples that are used for deriving the LIC parameters; T(xᵢ,yᵢ) is the template sample of the current block at the coordinate (xᵢ,yᵢ); T_{0/1}(xᵢ+vₓ^{0/1},yᵢ+v_{y}^{0/1}) is the corresponding reference sample of the template sample based on the motion vector (vₓ^{0/1},v_{y}^{0/1}) (either L0 or L1) of the current block. Additionally, to reduce the computational complexity, both the template samples and the reference template samples are subsampled (2:1 subsampling) to derive the LIC parameters, i.e., only the shaded samples in FIG. 2 are used to derive α and β.

Moreover, when LIC is applied to bi-directional blocks (i.e., being predicted by two temporal prediction blocks), the LIC parameters are derived and applied for each prediction direction, i.e., L0 and L1, separately. As shown in FIG. 2, based on the two motion vectors MV0 and MV1, two reference templates T0 and T1 can be obtained; by separately minimizing the distortions between T0 and T, and T1 and T, the corresponding pairs of LIC parameters in two directions can be derived according to equations (2) and (3). Afterwards, the final bi-directional prediction signal of the current block is generated by combining two LIC uni-prediction blocks, as indicated as:

$$P ( x , y ) = \frac{1}{2} \cdot ( {α}_{0} \cdot {P}_{r}^{0} ( x + {v}_{x}^{0} , y + {v}_{y}^{0} ) + {β}_{0} + {α}_{1} \cdot {P}_{r}^{1} ( x + {v}_{x}^{1} , y + {v}_{y}^{1} ) + {β}_{1} ) \qquad ( 2 )$$

where α₀ and β₀ and α₁ and β₁ are the LIC parameters associated with the L0 and L1 motion vectors (i.e., (vₓ⁰,v_{y}⁰) and (vₓ¹,vₓ¹)) of the current block; Pᵣ⁰(x+vₓ⁰,y+v_{y}⁰) and Pᵣ¹(x+vₓ¹,y+v_{y}¹) are the corresponding temporal reference blocks of the current block from list L0 and L1, respectively.

When an inter block is predicted with merge mode, LIC flag is included as a part of motion information in addition to MVs and reference indices. When merge candidate list is constructed, LIC flag is inherited from the neighbor blocks for merge candidates. Otherwise, LIC flag is context coded with a single context, when LIC tool is not applicable, LIC flag is not signaled.

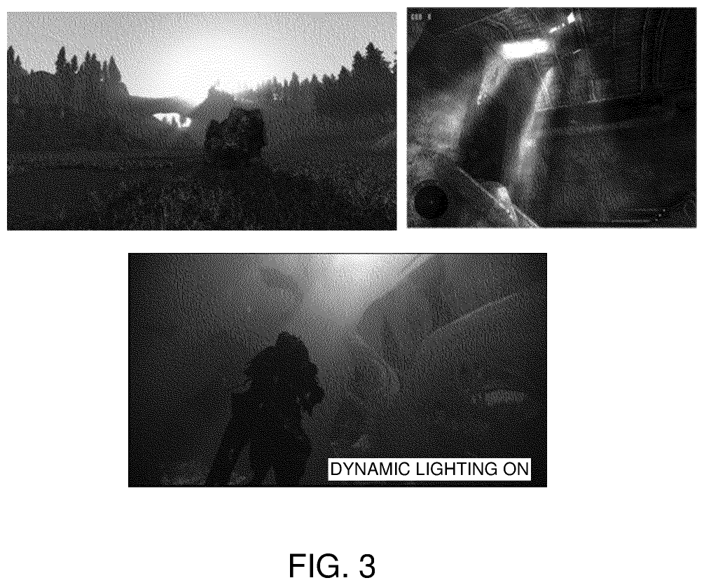

However, it is desirable to enhance the coding efficiency of some video contents that contain some gradual illumination variation inside a same picture. Such situation may typically happen in some gaming video content or computer graphic images where some illumination source is located at some place in the picture and light propagates gradually across the picture. FIG. 3 illustrates exemplary video game pictures with light sources creating a gradual illumination variation inside in the picture. In such case, the block to encode may contain some background content with gradually evolving luma value according to the spatial location, and some local specific texture elements that may be considered as foreground information. Such gradual illumination variation inside a same picture may also happen in natural images and the present principles are compatible with any type of video content.

As described above, the LIC can be considered as one enhancement of the regular motion-compensated prediction by addressing the illumination changes between different pictures at the motion compensation stage. Though the prior-art LIC can compensate illumination discrepancy between different pictures, it is neither applied nor adapted for the illumination compensation between different blocks in the same picture.

This is solved and addressed by the general aspects described herein, which are directed to determining, for a current block being decoded or decoded in a picture, parameters for a local illumination compensation based on spatially neighboring reconstructed samples and corresponding spatially neighboring reconstructed samples of at least one spatial reference block wherein the at least one spatial reference block is a spatially neighboring block of the current block in the picture. Thus, assuming one coding block and its spatial neighboring blocks inside the picture have the propagating illuminance variations, after generating the prediction signal of the block, the present principles propose to apply a spatial LIC to enhance the prediction. As the reference block is not located in the temporal reference pictures, but instead in the same picture, both the reference block search and the template used for the spatial LIC parameter estimation are adjusted. Moreover, the decision of spatial LIC flag, which indicates the usage of the spatial LIC, might also be defined. Besides, various embodiments of the spatial local illumination compensation (spatial LIC) for inter/intra/IBC prediction where different blocks with gradually propagating spatial illumination variation in the same picture are disclosed. In addition, various embodiments of shape of the template used in local illumination compensation (spatial/temporal LIC) are also disclosed.

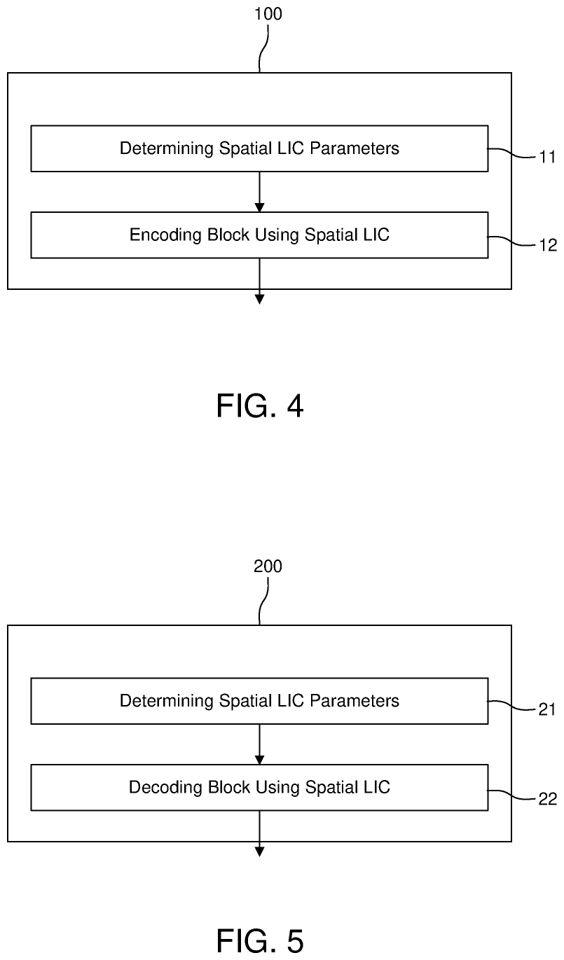

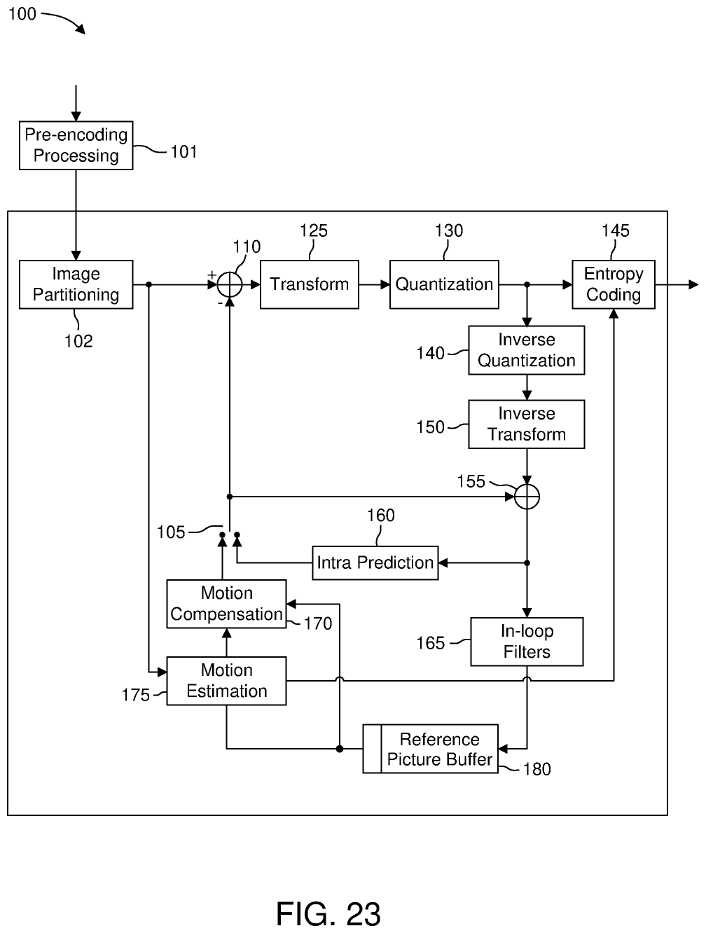

FIG. 4 illustrates a generic encoding method (100) according to a general aspect of at least one embodiment. The block diagram of FIG. 4 partially represents modules of an encoder or encoding method, for instance implemented in the exemplary encoder of FIG. 23.

According to a generic embodiment a method for encoding 100 is disclosed. The method comprises, determining 11 for a current block being encoded in a picture, parameters for a local illumination compensation based on spatially neighboring reconstructed samples and corresponding spatially neighboring reconstructed samples of at least one spatial reference block. Advantageously, the spatial reference block is a spatially neighboring block of the current block in the picture as described in various embodiments hereafter. Thus, the determined parameters for the local illumination compensation allows performing a spatial LIC. The spatial LIC is applied to a prediction of the current block to compensate for gradual illumination in the picture and results in a compensated prediction of the block. According to different embodiments, the prediction is one of an inter, intra or intra block copy (IBC) prediction. According to another embodiment, a syntax element indicating whether the spatial local illumination compensation applies on the current block or not is determined. After the spatial compensation of the prediction of the current block, a residual is for instance computed in the usual manner by subtracting the compensated prediction from the current block, and then the remaining processing (transform, quantization, CABAC encoding, etc.) is performed as in a state-of-the-art encoding method in a generic encoding step 12.

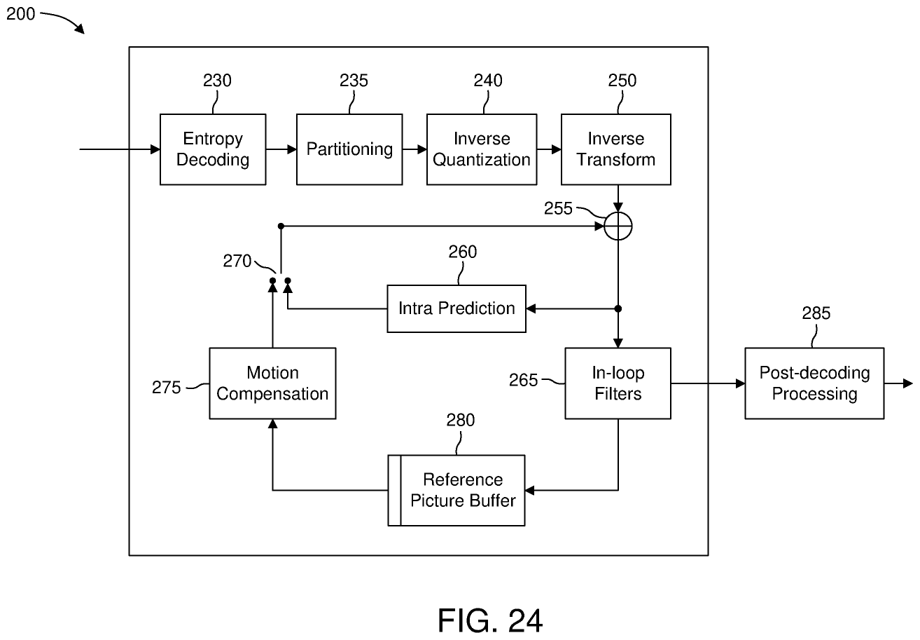

FIG. 5 illustrates a generic decoding method (200) according to a general aspect of at least one embodiment. The block diagram of FIG. 5 partially represents modules of a decoder or decoding method, for instance implemented in the exemplary decoder of FIG. 24.

According to a generic embodiment a method for decoding 200 is disclosed. The method comprises, determining 21 for a current block being decoded in a picture, parameters for a local illumination compensation based on spatially neighboring reconstructed samples and corresponding spatially neighboring reconstructed samples of at least one spatial reference block. As for the encoding, the spatial reference block is a spatially neighboring block of the current block in the picture as described in various embodiments hereafter. According to different embodiments, the spatial LIC is enabled/disabled for the current block using a dedicated flag and the spatial LIC is applied to one of an inter, intra or IBC prediction of the current block. The decoding 22 then further comprises for instance decoding the residual values by performing the CABAC decoding, dequantization of the transform coefficients and then the inverse transform of the decoded coefficients, and adding the so-decoded residual values to the compensated prediction to decode the current block.

Various embodiments of the generic spatial LIC used in an encoding or decoding method are described in the following. According to various embodiments, a block (or CU) level spatial LIC flag is defined for an inter/intra/IBC block to indicate whether the spatial LIC applies on the block or not. If the spatial LIC applies for an inter/intra/IBC block, according to another particular embodiment, a linear model for spatial illumination changes is defined using a scaling factor α and an offset β. The estimation of the spatial LIC parameters is derived by minimizing the difference between the neighboring reconstructed samples of the current block (current template) and the corresponding neighboring reconstructed samples of the spatial reference block (reference template) inside the same picture. Various embodiments described in the following relate to the derivation of the CU-level spatial LIC flag; the selection of a spatial neighboring block used as the reference block for spatial LIC parameters estimation, the generation of the template, which is composed by the neighboring reconstructed samples and is used for spatial LIC parameters estimation.

In the following, for the spatial LIC in inter prediction, its spatial LIC derivation, reference block decision and the generation of the template used for spatial LIC parameter estimation are described. Then, for the spatial LIC in intra prediction, the reference block decision and the template generation are also described, especially the difference compared to the spatial LIC in inter prediction. After, for the spatial LIC in IBC prediction, the reference block decision is also described. At last, the spatial reference block search for inter/inter prediction is proposed.

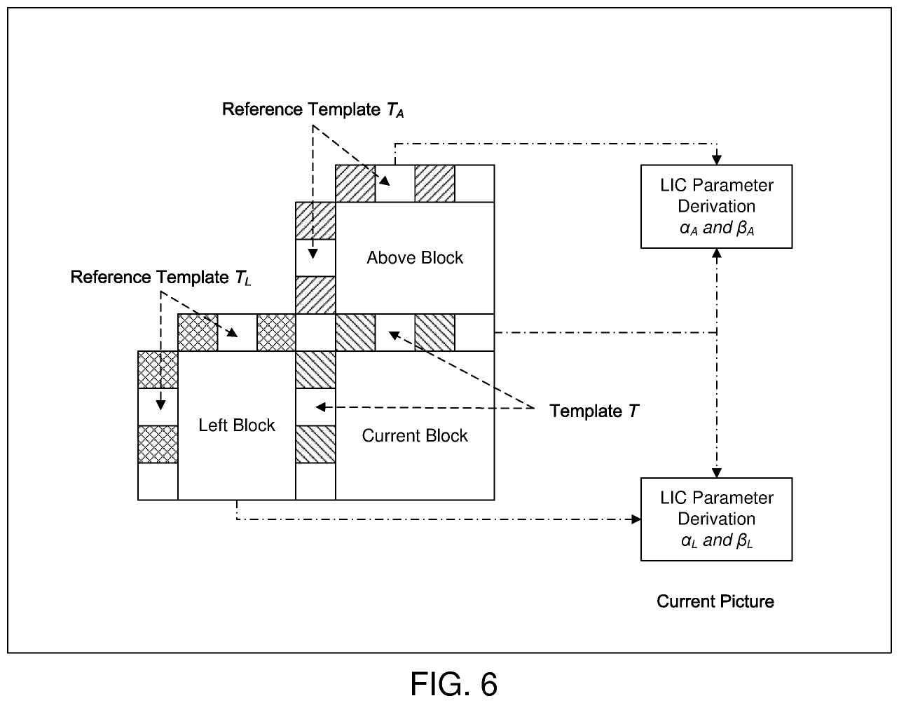

According to a first embodiment, spatial LIC is applied during the encoding/decoding of an inter block. FIG. 6 illustrates the deriving of spatial LIC parameters process with reference template of the above/left neighboring block for inter prediction according to at least one embodiment.

According to prior-art LIC tool described above, LIC is applied to compensate the temporal illumination changes between different frames in inter prediction and is referred as temporal LIC in the following. Given there might be some propagating illuminance variations between some spatial blocks inside the same frame, spatial LIC is proposed to further compensate the spatial illumination changes inside the same frame in inter prediction.

According to a variant embodiment, a spatial LIC flag spatial_lic_flag is defined to indicate whether spatial LIC applies or not. When an inter block is coded with merge mode, the spatial LIC flag is copied from neighboring blocks, in a way similar to motion information copy in merge mode; otherwise, the spatial LIC flag is signaled for the block.

According to another variant embodiment, when the spatial LIC applies for a CU, it is also based on a liner model for spatial illumination changes, using a scaling factor α and an offset β. The estimation of the spatial LIC parameters is derived by minimizing the difference between the neighboring reconstructed samples of the current block (i.e., the template T in FIG. 6) and the corresponding neighboring reconstructed samples of the spatial reference block inside the same picture.

In FIG. 6, the above/left spatial neighboring block of the current block is used as the reference block, and the neighboring reconstructed samples of the above/left block (i.e., either T_{A} or T_{L} in FIG. 6) are used for estimating the spatial LIC parameters. If the above spatial neighboring block of the current block is available, the above spatial LIC parameters (α₄ and β_{A}) are estimated with the LMSE-based LIC derivation as below:

$${α}_{A} = \frac{N \cdot {\sum }_{i = 1}^{N} ( T ( {x}_{i} , {y}_{i} ) \cdot {T}_{A} ( {x}_{i} , {y}_{i} - {h}_{A} ) ) - {\sum }_{i = 1}^{N} ( T ( {x}_{i} , {y}_{i} ) ) \cdot {\sum }_{i = 1}^{N} ( {T}_{A} ( {x}_{i} , {y}_{i} - {h}_{A} ) )}{N \cdot {\sum }_{i = 1}^{N} ( {T}_{A} ( {x}_{i} , {y}_{i} - {h}_{A} ) \cdot {T}_{A} ( {x}_{i} , {y}_{i} - {h}_{A} ) ) - {( {\sum }_{i = 1}^{N} {T}_{A} ( {x}_{i} , {y}_{i} - {h}_{A} ) )}^{2}} \qquad ( 5 )$$

$${β}_{A} = \frac{{\sum }_{i = 1}^{N} ( T ( {x}_{i} , {y}_{i} ) ) - {α}_{A} \cdot {\sum }_{i = 1}^{N} ( {T}_{A} ( {x}_{i} , {y}_{i} - {h}_{A} ) )}{N} \qquad ( 6 )$$

where N represents the number of template samples that are used for deriving the spatial LIC parameters; T(xᵢ,yᵢ) is the template sample of the current block at the coordinate (xᵢ,yᵢ); T_{A}(xᵢ,yᵢ−h_{A}) is the corresponding reconstructed sample of the template sample based on the above neighboring block (h_{A} is the height of the above block) of the current block. Additionally, to reduce the computational complexity, only the shaded samples in FIG. 6 are used to derive α_{A} and β_{A}.

Similar estimation process for the left spatial LIC parameters (α_{L} and β_{L}) is derived as below, if the left spatial neighboring block of the current block is available:

$${α}_{L} = \frac{N \cdot {\sum }_{i = 1}^{N} ( T ( {x}_{i} , {y}_{i} ) \cdot {T}_{L} ( {x}_{i} - {w}_{L} , {y}_{i} ) ) - {\sum }_{i = 1}^{N} ( T ( {x}_{i} , {y}_{i} ) ) \cdot {\sum }_{i = 1}^{N} ( {T}_{L} ( {x}_{i} - {w}_{L} , {y}_{i} ) )}{N \cdot {\sum }_{i = 1}^{N} ( {T}_{L} ( {x}_{i} - {w}_{L} , {y}_{i} ) \cdot {T}_{L} ( {x}_{i} - {w}_{L} , {y}_{i} ) ) - {( {\sum }_{i = 1}^{N} {T}_{L} ( {x}_{i} - {w}_{L} , {y}_{i} ) )}^{2}} \qquad ( 7 )$$

$${β}_{L} = \frac{{\sum }_{i = 1}^{N} ( T ( {x}_{i} , {y}_{i} ) ) - {α}_{L} \cdot {\sum }_{i = 1}^{N} ( {T}_{L} ( {x}_{i} - {w}_{L} , {y}_{i} ) )}{N} \qquad ( 8 )$$

where T_{L}(xᵢ−w_{L},yᵢ) is the corresponding reconstructed sample of the template sample based on the left neighboring block (w_{L} is the width of the left block) of the current block. Only the shaded samples in FIG. 6 are used to derive α_{L} and β_{L} to reduce the computational complexity.

If only above or left spatial neighboring block is available, the above spatial LIC parameters (α_{A} and β_{A}), or the left LIC parameters (α_{L} and β_{L}) are applied to the regular motion-compensated prediction samples to obtain the final prediction samples of the current block:

$$P ( x , y ) = {α}_{A / L} \cdot {P}_{r} ( x + {v}_{x} , y + {v}_{y} ) + {β}_{A / L} . \qquad ( 9 )$$

If both above and left spatial neighboring blocks are available, the above and left spatial LIC parameters are derived by separately minimizing the distortions between T_{A} and T, and T_{L} and T. Afterwards, the final prediction samples of the current block are generated by applying the final spatial LIC parameters, which are obtained by averaging the above and left spatial LIC parameters, as indicated as:

$$P ( x , y ) = \frac{1}{2} \cdot ( {α}_{A} + {α}_{L} ) \cdot {P}_{r} ( x + {v}_{x} , y + {v}_{y} ) + \frac{1}{2} \cdot ( {β}_{A} + {β}_{L} ) . \qquad ( 10 )$$

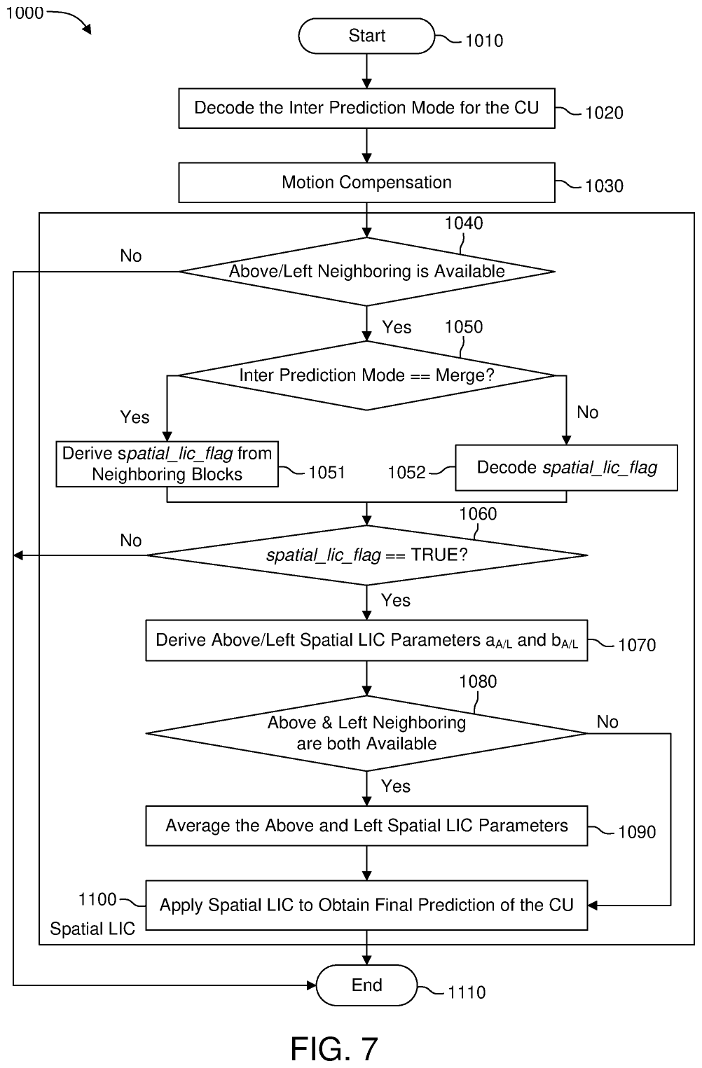

FIG. 7 illustrates a decoding method according to the first embodiment where spatial LIC is applied during the decoding of an inter block, for example using above/left neighboring blocks. The input to the algorithm is the current CU to decode in the current inter picture. If above or left spatial neighboring block of the current is available (step 1040), it consists in parsing a spatial LIC flag spatial_lic_flag, which indicates the usage of the proposed spatial LIC process in the current CU. For the merge mode, spatial_lic_flag is inferred from neighboring blocks, in a way similar to the prior-art LIC in Merge mode (step 1051). For the AMVP mode, spatial_lic_flag is decoded from the bitstream (step 1052).

In case spatial_lic_flag is false, then only the usual motion compensation decoding process is involved, for example as specified by the VVC decoding process. In case spatial_lic_flag is true, then the next step 1070 consists the estimation of spatial LIC parameters with available above/left spatial neighboring blocks. If both above and left spatial neighboring blocks are available (step 1080), the final spatial LIC parameters are obtained by averaging the above and left spatial LIC parameters in step 1090. Afterwards, as depicted in step 1100, the final prediction samples of the current block are generated by applying the spatial LIC parameters on the regular motion-compensated prediction samples.

According to a variant of this embodiment, only above or left spatial LIC parameters are applied on the regular motion-compensated prediction samples to obtain the final prediction samples of the current block, the decision of using which spatial reference block is, for instance, done via rate-distortion (RD) or sum absolute difference (SAD) check. A flag lic_refblk_flag to indicate which spatial reference block and the corresponding spatial LIC parameters set is applied, is signaled into the bitstream. When lic_refblk_flag equals to 0, then the left spatial LIC parameters are applied; otherwise, the above spatial LIC parameters are applied.

As aforementioned, when both above and left spatial neighboring blocks are available, the above and left spatial LIC parameters are separately derived; then, the above and left spatial LIC parameters are averaged to generate the final spatial LIC parameters and are applied to obtain the final prediction samples of the current block. Given that such method needs to perform the LMSE-based spatial LIC derivation twice, it introduces non-negligible complexity increase at both encoder and decoder.

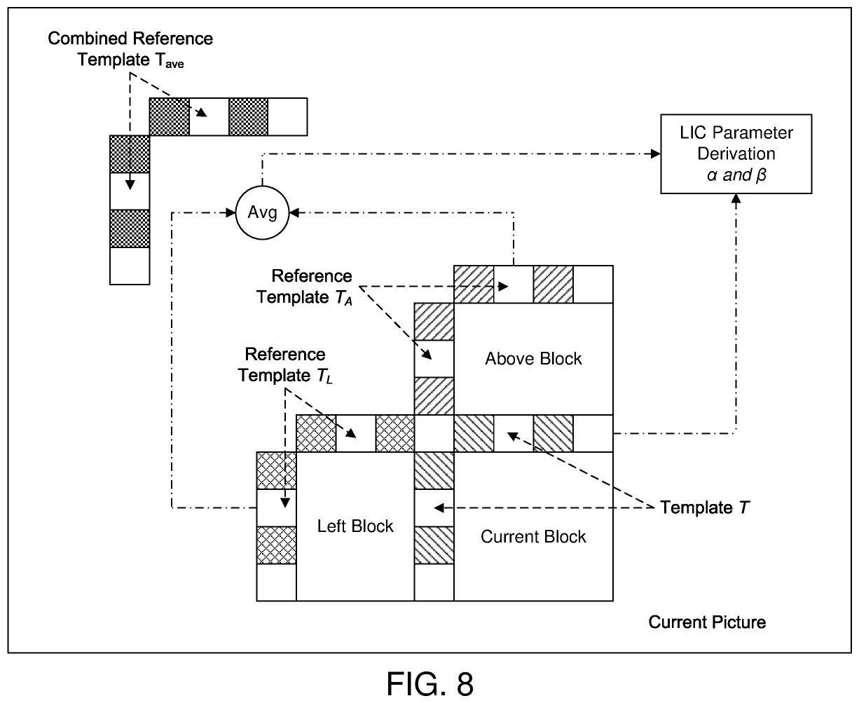

According to another variant of this embodiment, to reduce the complexity of the proposed spatial LIC derivation, one improved spatial LIC algorithm is proposed for the case when both above and left spatial neighboring blocks are available. FIG. 8 illustrates the deriving of spatial LIC parameters process with an average reference template of the above and left neighboring block for inter prediction according to at least one embodiment. Specifically, instead of separately deriving the above and left spatial LIC parameters, the reference template Tₐᵥₑ is firstly generated by averaging reconstructed samples of the two templates T_{A} in the above block and T_{L} in the left block:

$${T}_{a v e} ( x , y ) = \frac{1}{2} \cdot ( {T}_{A} ( x , y - {h}_{A} ) + {T}_{L} ( x - {w}_{L} , y ) ) . \qquad ( 11 )$$

After that, the LMSE-based derivation is employed to calculate the values of the scaling factor α and the offset β used for the spatial LIC by minimizing the difference between the reference template Tₐᵥₑ and the template of current block T as below:

$$α = \frac{N \cdot {\sum }_{i = 1}^{N} ( T ( {x}_{i} , {y}_{i} ) \cdot {T}_{a v e} ( {x}_{i} , {y}_{i} ) ) - {\sum }_{i = 1}^{N} ( T ( {x}_{i} , {y}_{i} ) ) \cdot {\sum }_{i = 1}^{N} ( {T}_{a v e} ( {x}_{i} , {y}_{i} ) )}{N \cdot {\sum }_{i = 1}^{N} ( {T}_{a v e} ( {x}_{i} , {y}_{i} ) \cdot {T}_{a v e} ( {x}_{i} , {y}_{i} ) ) - {( {\sum }_{i = 1}^{N} {T}_{a v e} ( {x}_{i} , {y}_{i} ) )}^{2}} \qquad ( 12 )$$

$$β = \frac{{\sum }_{i = 1}^{N} ( T ( {x}_{i} , {y}_{i} ) ) - α \cdot {\sum }_{i = 1}^{N} ( {T}_{a v e} ( {x}_{i} , {y}_{i} ) )}{N} \qquad ( 13 )$$

Finally, the derived spatial LIC parameters are applied on the regular motion-compensated prediction samples to obtain the final prediction samples of the current block based on the linear model as shown on FIG. 8.

Therefore, for this variant, only one spatial LIC parameter estimation needs to be performed to form the final prediction samples of the current block.

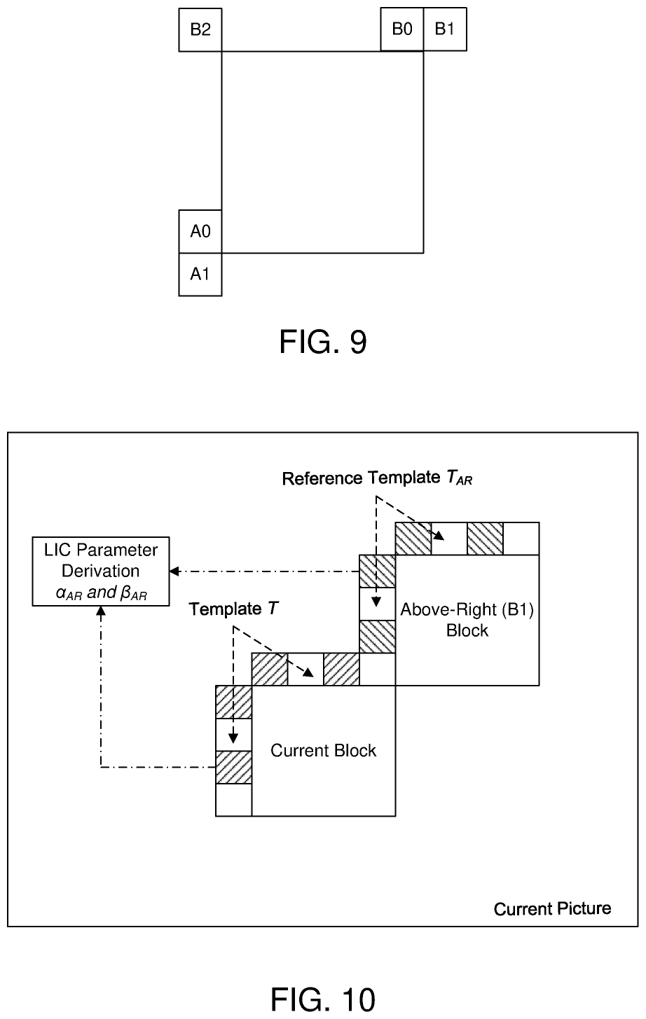

According to a second embodiment, the motion vector prediction (MVP) candidate is used as the reference block in inter prediction. FIG. 9 illustrates the positions of the spatial MVP candidates in VVC. For inter prediction, MV can be signaled either in merge or AMVP mode. Both signaling mechanism utilizes a motion vector prediction (MVP) list basically constructed from motion information available from spatial or temporal neighboring of the currently coded blocks. The positions of the spatial MVP candidates are depicted in FIG. 9. The order of derivation is B0 (above), A0 (left), B1 (above-right), A1 (bottom-left) and B2 (above-left). Rather than only using the above (B0) and left (A0) spatial neighboring block of the current block as the reference block as previously described, other spatial neighboring blocks for MVP list construction are also considered as the reference block candidates for the spatial LIC. If the spatial LIC is applied for the current block, once one of the five spatial candidates is selected as best MVP candidate, the spatial LIC parameters are automatically derived with the corresponding selected spatial neighboring block.

FIG. 10 illustrates the deriving of spatial LIC parameters process with reference template of the above-right (B1) neighboring block for inter prediction according to at least one embodiment. If the above-right (B1) spatial neighboring block of the current block is selected, it is used as the reference block for the spatial LIC, as shown on FIG. 10. The neighboring reconstructed samples of the above-right block (T_{AR} in FIG. 10) are used for estimating the spatial LIC parameters. The above-right spatial LIC parameters (α_{AR} and β_{AR}) are estimated with the LMSE-based LIC derivation as below:

$${α}_{AR} = \frac{N \cdot {\sum }_{i = 1}^{N} ( T ( {x}_{i} , {y}_{i} ) \cdot {T}_{AR} ( {x}_{i} + {w}_{AR} , {y}_{i} - {h}_{AR} ) ) - {\sum }_{i = 1}^{N} ( T ( {x}_{i} , {y}_{i} ) ) \cdot {\sum }_{i = 1}^{N} ( {T}_{AR} ( {x}_{i} + {w}_{AR} , {y}_{i} - {h}_{AR} ) )}{N \cdot {\sum }_{i = 1}^{N} ( {T}_{AR} ( {x}_{i} + {w}_{AR} , {y}_{i} - {h}_{AR} ) \cdot {T}_{AR} ( {x}_{i} + {w}_{AR} , {y}_{i} - {h}_{AR} ) ) - {( {\sum }_{i = 1}^{N} {T}_{AR} ( {x}_{i} + {w}_{AR} , {y}_{i} - {h}_{AR} ) )}^{2}} \qquad ( 14 )$$

$${β}_{A R} = \frac{{\sum }_{i = 1}^{N} ( T ( {x}_{i} , {y}_{i} ) ) - {α}_{A R} \cdot {\sum }_{i = 1}^{N} ( {T}_{A R} ( {x}_{i} + {w}_{AR} , {y}_{i} - {h}_{A R} ) )}{N} \qquad ( 15 )$$

where T_{AR}(xᵢ+w_{AR},yᵢ−h_{AR}) is the corresponding reconstructed sample of the template sample based on the above-right neighboring block (h_{AR} and w_{AR} are the height and width of the above-right block). Similar spatial LIC parameters derivation process could be performed for bottom-left (A1) and above-left (B2) spatial neighboring blocks if they are selected.

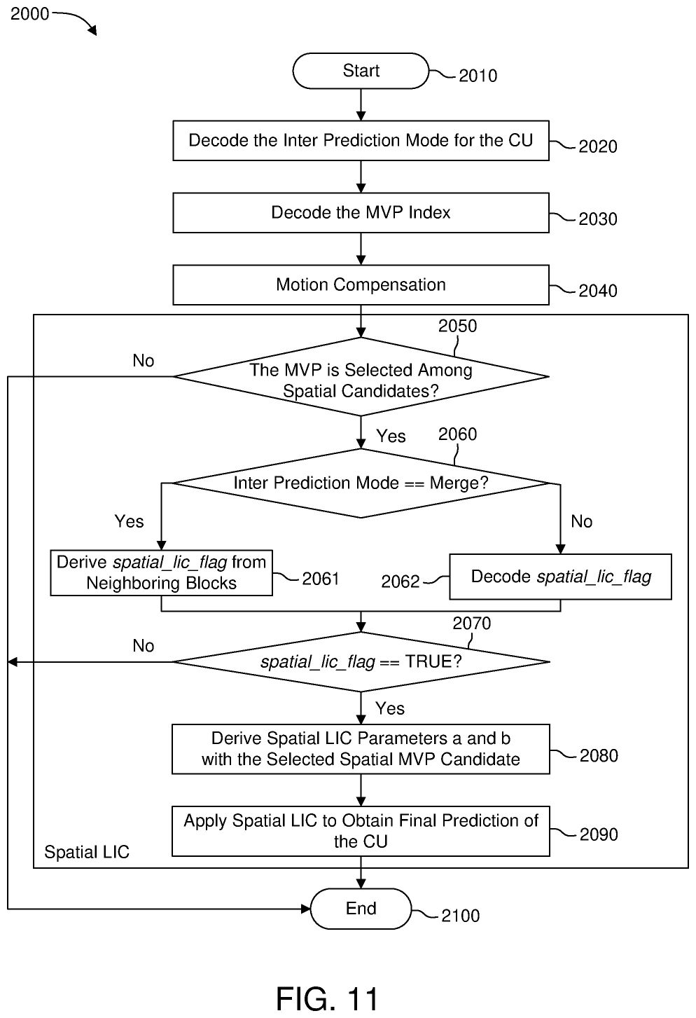

FIG. 11 illustrates a decoding method according to the second embodiment where spatial LIC is applied during the decoding of an inter block based on MVP candidates. If the MVP is one of the five spatial MVP candidates (step 2050), the method comprises parsing a spatial LIC flag spatial_lic_flag, which indicates the usage of the proposed spatial LIC process in the current CU. For the merge mode, spatial_lic_flag is inferred from neighboring blocks, in a way similar to the prior-art LIC in Merge mode (step 2061). For the AMVP mode, spatial_lic_flag is decoded from the bitstream (step 2062).

In case spatial_lic_flag is false, then only the usual motion compensation decoding process is involved. In case spatial_lic_flag is true, then the next step 2080 comprises estimating the spatial LIC parameters with the corresponding selected spatial neighboring block. Afterwards, as depicted in step 2090, the final prediction samples of the current block are generated by applying the spatial LIC parameters on the regular motion-compensated prediction samples. According to yet another variant of this embodiment, if the spatial LIC is applied for the current block, rather than only one of the five spatial candidates is selected as best MVP candidate, the spatial LIC parameters from these five spatial neighboring blocks are applied to obtain the final prediction samples of the current block. The decision of using which spatial reference block set could be done via rate-distortion (RD) or sum absolute difference (SAD) check. An index lic_refblk_index indicating which spatial reference block and the corresponding spatial LIC parameters set is applied, is signaled into the bitstream.

According to a third embodiment, spatial LIC is applied during the encoding/decoding of an intra block. As aforementioned for inter prediction, the spatial LIC is proposed to compensate the spatial illumination changes inside the same frame. While the illumination changes could propagate gradually across the intra coded frame, the intra block to encode/decode might also contain those gradually propagating spatial illumination variation.

As specified by the VVC, Planar and DC intra prediction modes are used to predict smooth and gradually changing regions, whereas angular prediction modes are used to capture different directional structures. However, even DC and planar intra prediction modes are targeted for the smooth and gradually changing contents, they are unable to properly handle some contents with directional gradual and propagating illumination variations; similar limits for other directional intra prediction modes. Therefore, the third embodiment proposes to apply spatial LIC to compensate the spatial illumination changes for intra prediction.

As previously described for inter block, a spatial LIC flag spatial_lic_flag is defined and signaled for an intra block to indicate whether spatial LIC applies or not. When the spatial LIC applies, it is also based on a linear model for spatial illumination changes, using a scaling factor α and an offset β. The estimation of the spatial LIC parameters is also derived by minimizing the difference between the neighboring reconstructed samples of the current block and the corresponding neighboring reconstructed samples of the spatial reference block inside the picture.

As for selecting the possible spatial reference block, there are some differences between spatial LIC for inter prediction and intra prediction. For example, the spatial neighboring block used for estimating spatial LIC parameters is determined based on the intra prediction mode. Moreover, rather than considering both above and left boundaries, only above or left boundary is used to compose the template, which then is used for estimating spatial LIC parameters. Besides, according to yet another variant, the template is generated by more than just the reconstructed samples in the neighboring first above/left line, for example, the reconstructed samples in the second/third, or more above/left lines, or the whole reconstructed neighboring blocks. According to another variant embodiment, the proposed spatial LIC for intra prediction, is only activated for some intra prediction modes (i.e. DC and planar modes).

According to a variant of the third embodiment, spatial LIC is applied during the encoding/decoding of an intra block based on intra prediction mode. The spatial LIC parameters for intra prediction are estimated with the LMSE-based LIC derivation using the neighboring reconstructed samples of the nearest reconstructed spatial neighboring blocks (i.e. above/left/above-right/bottom-left/above-left in FIG. 9). According to non-limiting examples, the decision of using which spatial neighboring block is done via rate-distortion (RD) or sum absolute difference (SAD) check. An index lic_refblk_index to indicate which spatial reference block and the corresponding spatial LIC parameters set is applied, is signaled into the bitstream.

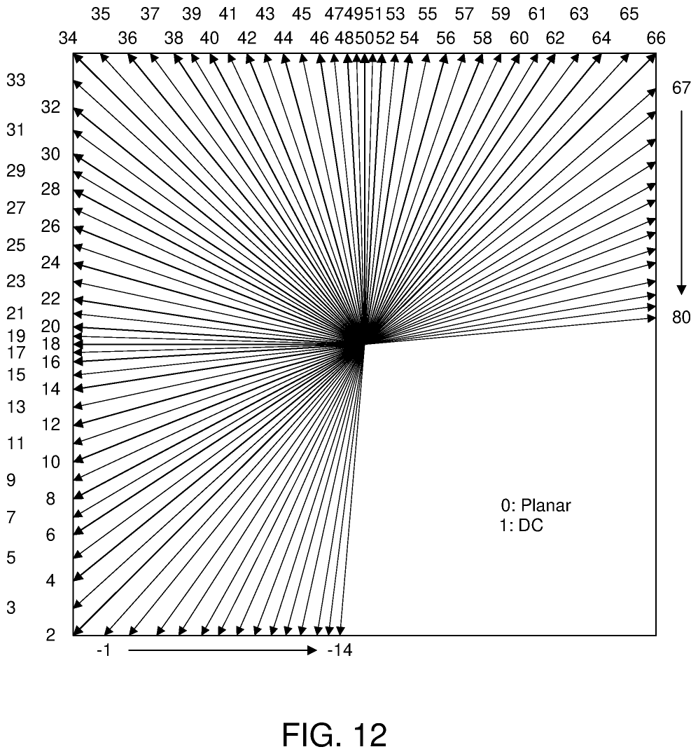

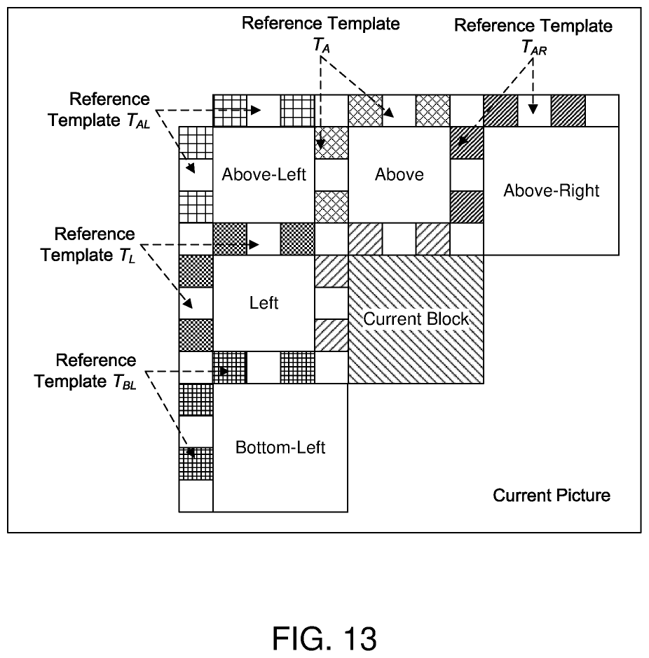

FIG. 12 illustrates the intra prediction directions in VVC. VVC supports 95 directional prediction modes which are indexed from −14 to −1 and from 2 to 80. For a square CU, only the prediction modes 2-66 are used. These prediction modes correspond to different prediction directions from 45 degree to −135 degree in clockwise direction. For a rectangular block, wide angular modes (−14 to −1 or 67 to 80) could be applied. For some flat blocks (W>H) and tall blocks (W<H), they use wide angular modes to replace equal number of regular angular modes in the opposite direction. According to a variant, rather than indicating which spatial neighboring block is applied with an addition syntax element, the reference block in spatial LIC for intra prediction could is decided based on the intra prediction mode (IPM). FIG. 13 illustrates the deriving of spatial LIC parameters process with reference template of the above/left/above-right/bottom-left/above-left neighboring block for intra prediction according to a third embodiment wherein the spatial reference block is responsive to an intra prediction mode used to code the current block. Accordingly:
for non-angular modes, planar (IPM equals to 0) and DC (IPM equals to 1), the neighboring reconstructed samples of the above and left blocks (T_{A} and T_{L} in FIG. 13) are used for estimating the spatial LIC parameters;
for Horizontal mode (IPM is 18) and other 30 modes belong to horizontal directions (IPM 3 to 33), only left block is used as the reference block and its neighboring reconstructed samples (T_{L} in FIG. 13) are used for spatial LIC parameters estimation; on the other hand, for the Vertical mode (IPM is 50) and other 30 modes belong to vertical directions (IPM 35 to 65), only the neighboring reconstructed samples of the above block (T_{A} in FIG. 13) are used for spatial LIC parameters estimation;
for diagonal modes that represent angles which are multiple of 45 degree:
   for 45° mode (IPM is 2), the neighboring reconstructed samples of the bottom-left block (T_{BL} in FIG. 13) are used for spatial LIC parameters estimation;
   for −45° mode (IPM is 34), the neighboring reconstructed samples of the above-left block (T_{AL} in FIG. 13) are used;
   for −135° mode (IPM is 66), the neighboring reconstructed samples of the above-right block (T_{AR} in FIG. 13) are used;
for wide angular modes beyond the bottom-left direction (IPM −1 to −14), the bottom-left block is used as the reference block and its neighboring reconstructed samples (T_{BL} in FIG. 13) are used for spatial LIC parameters estimation; on the other hand, for wide angular modes beyond the above-right direction (IPM 67 to 80), the neighboring reconstructed samples of the above-right block (T_{AR} in FIG. 13) are used for spatial LIC parameters estimation.

The template used for estimating spatial LIC parameters respects to the intra prediction mode IPM as shown in Table 1.

TABLE 1
mapping between intra prediction modes
and template used for spatial LIC.

| Template | T_{BL} | T_{L} | T_{A} | T_{AR} | T_{AL} |
|---|---|---|---|---|---|
| IPM | −14 to −1, 2 | 0, 1, 3 to 30 | 0, 1, 35 to 65 | 66 to 80 | 34 |

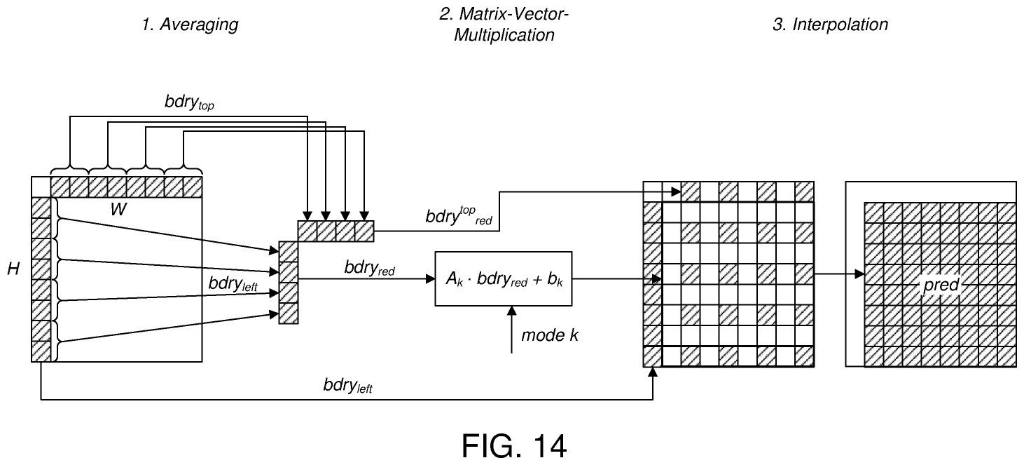

According to another variant of the third embodiment, the intra prediction mode is a matrix weighted intra prediction. FIG. 14 illustrates the matrix weighted intra prediction process in VVC. Besides conventional intra prediction, the matrix weighted intra prediction (MIP) method is a newly added intra prediction technique into VVC. For predicting the samples of a rectangular block of width W and height H, MIP takes one line of H reconstructed neighboring boundary samples left of the block and one line of W reconstructed neighboring boundary samples above the block as input if these reconstructed samples are available. The generation of the prediction signal is based on the following three steps, which are averaging, matrix vector multiplication and linear interpolation as shown in FIG. 14. For each CU in intra mode, a flag mip_flag indicating whether an MIP mode is to be applied or not is sent.

If spatial LIC is applied for this intra coded CU with MIP, the templates used for estimating spatial LIC parameters are the same as the CU with non-angular modes, both the neighboring reconstructed samples of the above and left blocks (T_{A} and T_{L} in FIG. 13) are used.

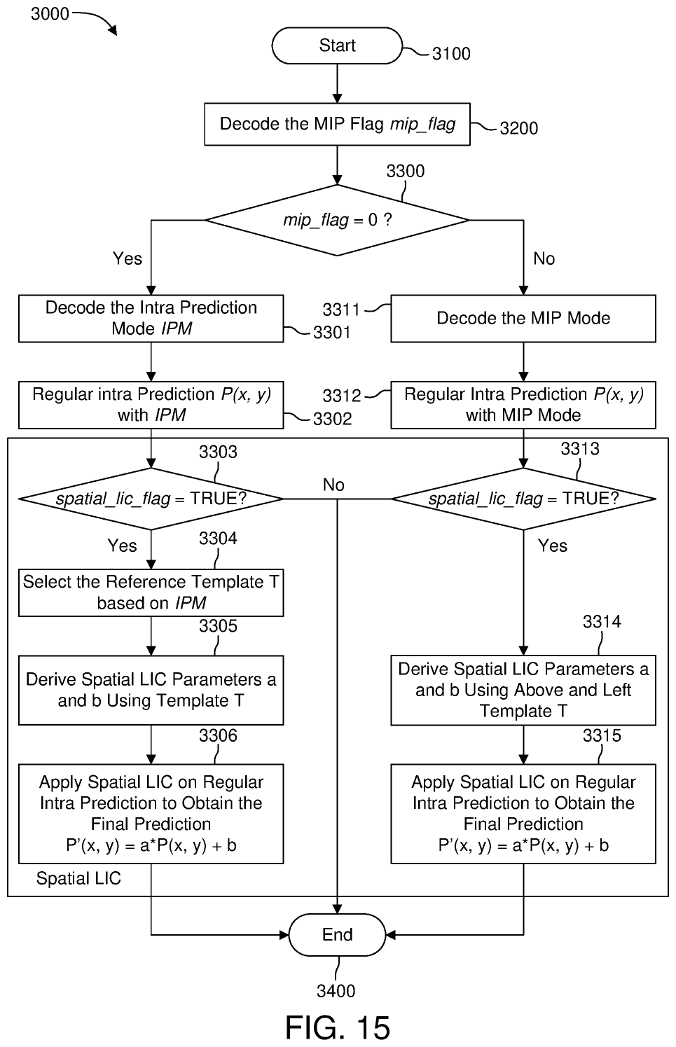

FIG. 15 illustrates a decoding method according to a third embodiment where spatial LIC is applied during the decoding of an intra block. Same as the spatial LIC for inter prediction, it comprises parsing a spatial LIC flag spatial_lic_flag, which is decoded from the bitstream (step 3303/3313). In case spatial_lic_flag is false, then only the usual intra prediction decoding process is involved. In case spatial_lic_flag is true, the proposed spatial LIC process is performed on the decoded intra prediction of the current CU with following steps.

If this block is intra predicted with MIP (step 3300), the estimation of spatial LIC parameters with the spatial above and left neighboring block are performed (step 3314). If this block is intra predicted with conventional intra prediction, the template decision for the spatial LIC parameters is based on the intra prediction mode IPM (step 3304). Then the next step 3305 consists the estimation of spatial LIC parameters with the corresponding selected templates. Afterwards, as depicted in step 3306/3315, the final prediction samples of the current block are generated by applying the spatial LIC parameters on the regular intra prediction samples. According to a variant of this embodiment, for DC and planar modes, rather than only using the above and left spatial neighboring block of the current block as the reference blocks, the other three templates from bottom-left, above-left, and above-right could also be used together for the spatial LIC parameters.

According to another variant of this embodiment, rather than only one of the five spatial templates is selected as the template for estimating spatial LIC parameters when the intra prediction mode belongs to horizontal/vertical direction, two or three templates could be used together to calculate the spatial LIC parameters. For example, for modes belong to horizontal directions (IPM 3 to 33), left, bottom-left and above-left blocks could be used as the reference blocks and its neighboring reconstructed samples (T_{L}, T_{BL} and T_{AL} in FIG. 13) are used for spatial LIC parameters estimation; as for modes belong to vertical directions (IPM 35 to 65), above, above-right and above-left templates (T_{A}, T_{AR} and T_{AL} in FIG. 13) could be used as the reference template for spatial LIC parameters estimation. These templates are working together in a similar behavior as the left and above templates for DC and Planar modes.

According to additional variants of the third embodiment, several shapes for the template used for estimating spatial LIC parameters are disclosed. As aforementioned, the template used for estimating spatial LIC parameters is always L-shape around the current/reference block, which is composed by the neighboring reconstructed samples located in the left and above boundaries of the current/reference block. Rather than using this fixed L-shape template, some more flexible template generations are proposed in this section.

According to a first variant, only left or above boundary of a spatial reference block are used as template. According to a previous variant of the third embodiment, the selection of the reference template is derived from the intra prediction mode IPM to enhance the different impact of illumination changes from left and above reference samples under some situations. For modes belong to horizontal directions (IPM 3 to 33), left reference template (T_{L} in FIG. 13) is used for spatial LIC parameters estimation; as for modes belong to vertical directions (IPM 35 to 65), above reference template (T_{A} in FIG. 13) is considered. While for either left or above reference template, it contains both reconstructed samples located in the left and above boundaries. To better capture the propagation of the illumination changes, also to reduce the calculation complexity of spatial LIC parameters estimation, only the reconstructed samples located in one boundary are used to compose the template.

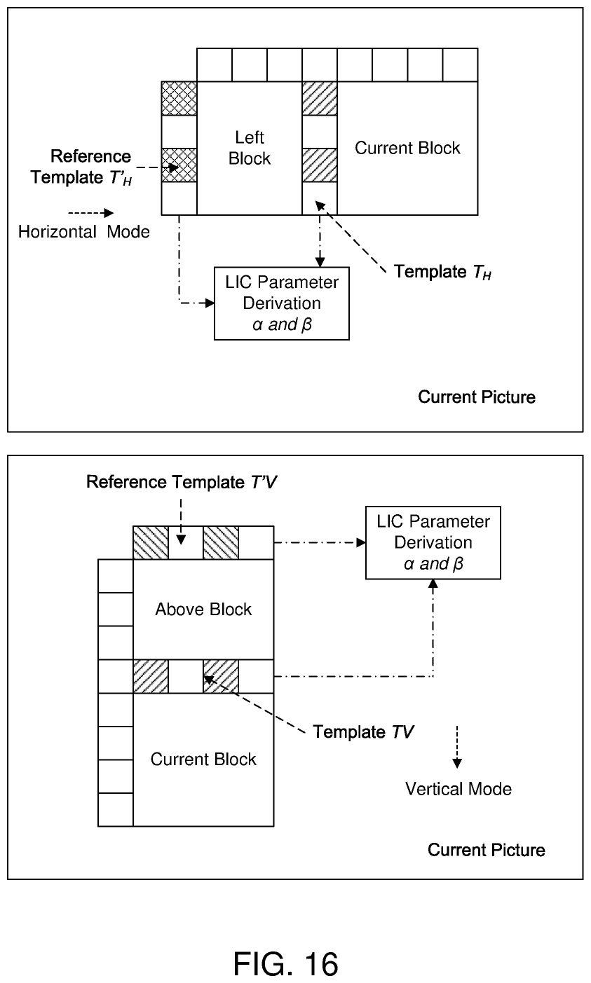

FIG. 16 illustrates the deriving of spatial LIC parameters process with reference template comprising the left boundary of a left neighboring block for intra prediction and with reference template comprising the above boundary of an above neighboring block for intra prediction according to at least one embodiment. For example, for horizontal directional modes (IPM 3 to 33), only the reconstructed samples located in left boundary are used to generate the template of the current block (T_{H} in the left of FIG. 16) and the template of the reference block (T′_{H} in the left of FIG. 16); as for vertical directional modes (IPM 35 to 65), and only the above boundary is considered to generate the template of the current block (T_{V} in the right of FIG. 16) and the template of the reference block (T′_{V} in the right of FIG. 16).

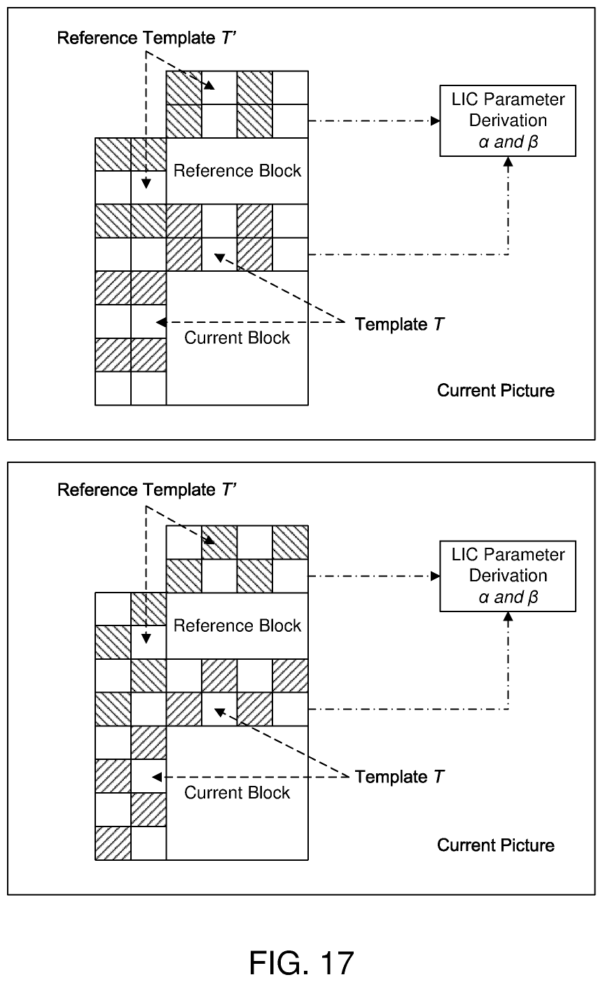

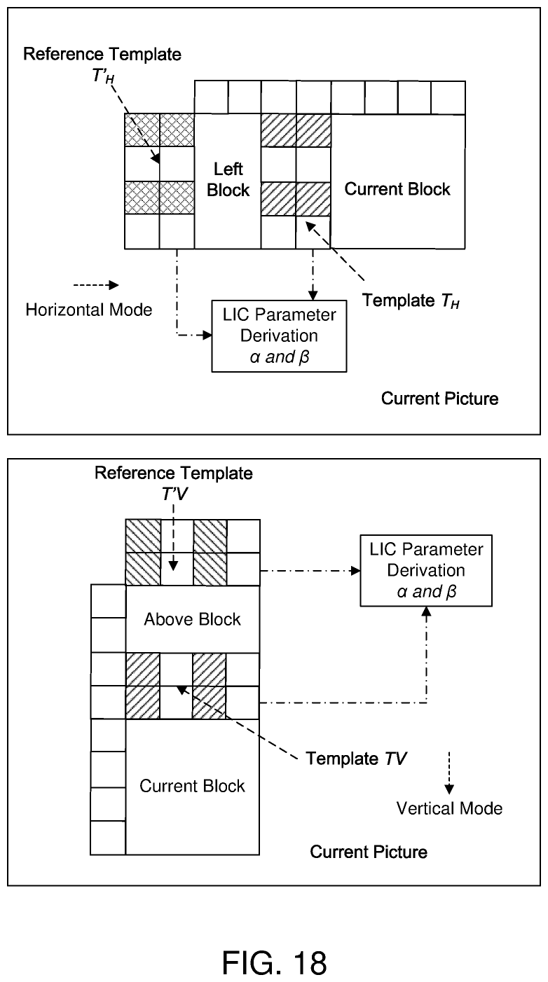

According to a second variant, multi reference lines of a spatial reference block are used as template. FIG. 17 illustrates the deriving of spatial LIC parameters process with multiple lines reference template of a spatial neighboring block according to at least one embodiment. So far, the template for the proposed spatial LIC only uses the reconstructed samples located in the nearest reference line (above/left boundary). For better capture and compensate illumination discrepancy, multi reference lines are used to compose the template. As shown in FIG. 17, an example of two reference lines is depicted, where neighboring reconstructed samples located in one additional left and above line are used for generating the template of the current block (T in FIG. 17) and the template of the reference block (T′ in FIG. 17). To reduce the computational complexity, the template samples in the two reference lines are both subsampled (2:1 subsampling). It could be either subsampled at the same position for both reference lines (in the top example of FIG. 17), or at the interlace position (in the down example of FIG. 17).

According to another variant, left-boundary template is applied for horizontal directional modes; and above-boundary template is used for vertical directional modes. The computational complexity is reduced with fewer samples in the template, meanwhile the estimation accuracy of the illumination variation might also be influenced. Therefore, according to another variant of this embodiment, multi reference lines from only left/above side are applied for horizontal/vertical directional modes. FIG. 18 illustrates another deriving of spatial LIC parameters process with multiple lines reference template of a spatial neighboring block for intra prediction according to at least one embodiment. An example of two reference lines from the same side of only one spatial reference block is shown in FIG. 18. For intra prediction modes, the left lines are used for horizontal directional modes (in the top example of FIG. 18), and the right lines are used for vertical directional modes (in the down example of FIG. 18).

According to another variant, a flag lic_mrl_flag indicating whether multi reference lines are applied for composing the template, is signaled into the bitstream. In case lic_mrl_flag is false, only the conventional nearest reference line (above/left boundary) will be applied for generating the template.

According to another variant, the template with multi reference line is applied in the spatial LIC parameters estimation for inter prediction. Indeed, different aspects of the multiple lines reference template are described with for spatial LIC applied in Intra prediction. However, this is for purposes of clarity in description, and does not limit the application or scope of those aspects neither to Intra prediction, nor to spatial LIC. Indeed, any of the different aspects can be combined and interchanged to provide template with multi reference line applied in the spatial LIC parameters estimation for inter prediction, or template with multi reference line is applied in the prior-art LIC parameters estimation for inter prediction.

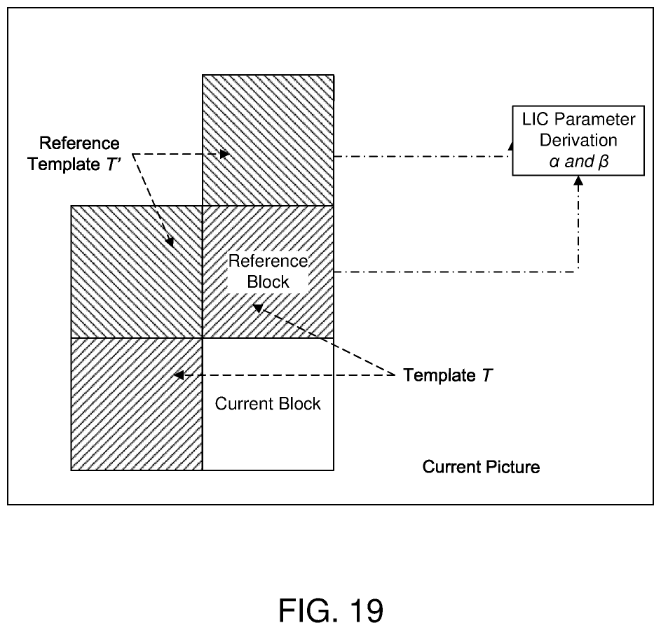

According to another variant, the template comprises a whole reconstructed neighboring block. FIG. 19 illustrate the deriving of spatial LIC parameters process with reference template comprising a spatial neighboring block according to at least one embodiment. To further improve the estimation accuracy of the illumination variation, also without considering the computational complexity, the template is generated by using all the reconstructed samples of the neighboring blocks since they are available. As an example, any of the reconstructed left and above neighboring blocks of the current block are used for generating the template of current block (T in FIG. 19), or any of the reconstructed left and above neighboring blocks of the reference block composes the template of reference block (T′ in FIG. 19).

According to a variant, only for small blocks (block size ≤8×8), the template is generated using reconstructed neighboring block. Advantageously, this feature allows to reduce the complexity of the variant of FIG. 19.

According to another variant, using the reconstructed neighboring block as the template is applied in the spatial LIC parameters estimation for inter prediction or in the prior-art LIC parameters estimation for inter prediction.

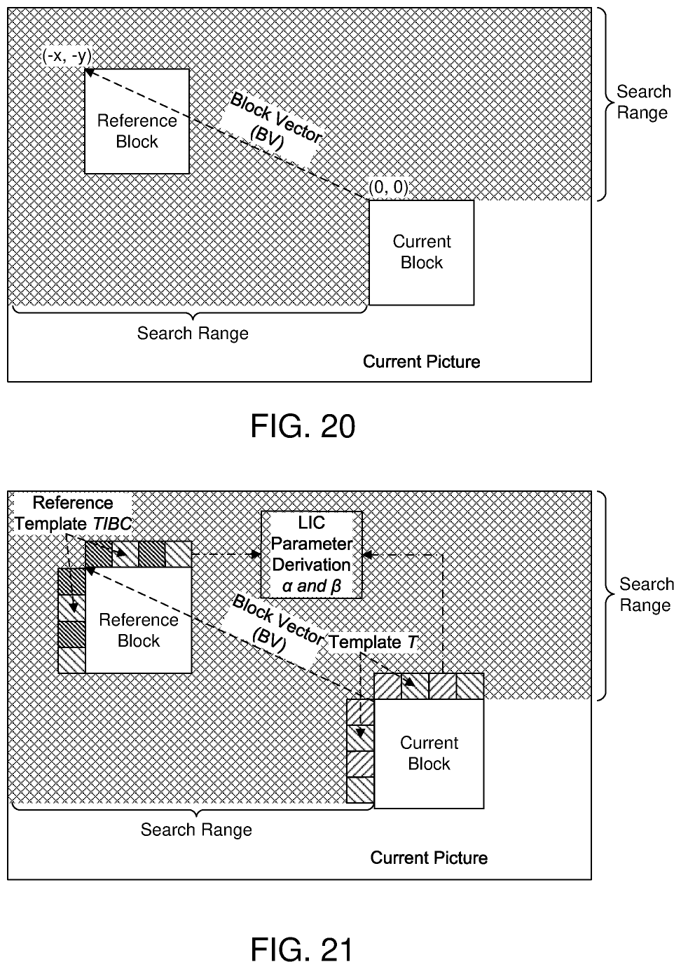

According to a fourth embodiment, spatial LIC is applied during the encoding/decoding of an IBC block. FIG. 20 illustrates the IBC prediction in VVC. Intra block copy (IBC) is a screen content coding (SCC) tool implemented in VVC. For IBC prediction, block matching (BM) is performed at the encoder to find the optimal block vector (or motion vector) for each CU (as shown in FIG. 20). Here, a block vector is used to indicate the displacement from the current block to a reference block, which is already reconstructed inside the current picture. An IBC-coded CU is treated as the third prediction mode other than intra or inter prediction modes. IBC is well known to significantly improve the coding efficiency of screen content materials (including gaming video contents). Therefore, the fourth embodiment relates to applying spatial LIC to compensate the spatial illumination changes for IBC prediction.

Compared to the spatial LIC for inter/intra prediction as described above, the spatial reference block, which is used for spatial LIC estimation for IBC prediction, is the same reference block used for intra copy (i.e., the template T_{IBC} in FIG. 21). In this case, the estimation process of the spatial LIC parameters for IBC (α_{IBC} and β_{IBC}) is derived as below:

$${α}_{IBC} = \frac{N \cdot {\sum }_{i = 1}^{N} ( T ( {x}_{i} , {y}_{i} ) \cdot {T}_{IBC} ( {x}_{i} - b {v}_{x} , {y}_{i} - b {v}_{y} ) ) - {\sum }_{i = 1}^{N} ( T ( {x}_{i} , {y}_{i} ) ) \cdot {\sum }_{i = 1}^{N} ( {T}_{IBC} ( {x}_{i} - b {v}_{x} , {y}_{i} - b {v}_{y} ) )}{N {\sum }_{i = 1}^{N} ( {T}_{IBC} ( {x}_{i} - b {v}_{x} , {y}_{i} - b {v}_{y} ) \cdot {T}_{IBC} ( {x}_{i} - b {v}_{x} , {y}_{i} - b {v}_{y} ) ) - {( {\sum }_{i = 1}^{N} {T}_{IBC} ( {x}_{i} - b {v}_{x} , {y}_{i} - b {v}_{y} ) )}^{2}} \qquad ( 16 )$$

$${β}_{IBC} = \frac{{\sum }_{i = 1}^{N} ( T ( {x}_{i} , {y}_{i} ) ) - {α}_{IBC} \cdot {\sum }_{i = 1}^{N} ( {T}_{IBC} ( {x}_{i} - b {v}_{x} , {y}_{i} - b {v}_{y} ) )}{N} \qquad ( 17 )$$

where T_{IBC}(xᵢ−bvₓ,yᵢ−bv_{y}) is the corresponding reference sample of the template sample based on the block vector (bvₓ, bv_{y}) of the current block.

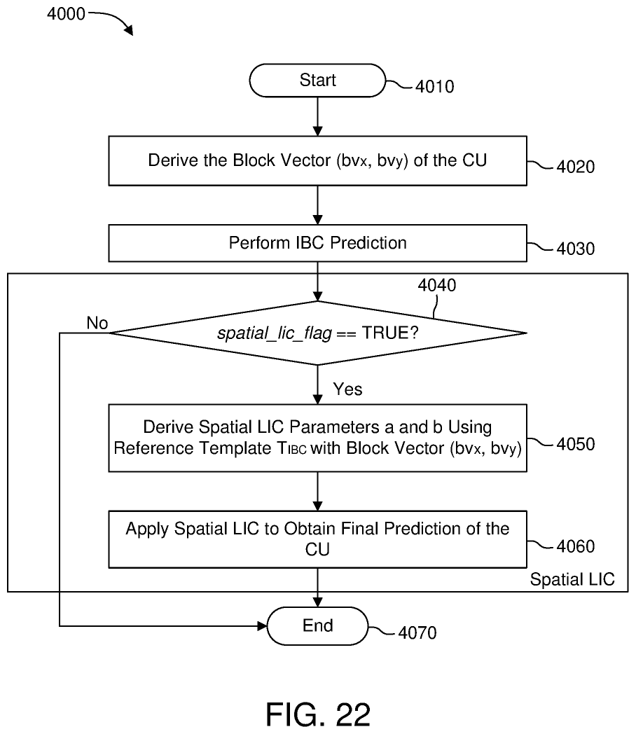

FIG. 22 depicts the decoding process according to the fourth basic embodiment where spatial LIC is applied during the decoding of an IBC block. The input to the algorithm is the current IBC CU to decode in the current intra picture. It consists in parsing a spatial LIC flag spatial_lic_flag, which indicates the usage of the proposed spatial LIC process in the current CU (step 4030). In case spatial_lic_flag is false, then only the usual IBC prediction decoding process is involved. In case spatial_lic_flag is true, the spatial reference block, indicating with a block vector (bvₓ, bv_{y}) of the current block, is used for the estimation of spatial LIC parameters (step 4050). Afterwards, as depicted in step 4060, the final prediction samples of the current block are generated by applying the spatial LIC parameters on the IBC prediction samples.

According to a fifth embodiment, the spatial reference block is searched in spatial LIC for intra and inter prediction. As aforementioned, the spatial LIC parameters for intra/inter prediction are estimated using the nearest reconstructed spatial neighboring blocks (above/left/above-right/bottom-left/above-left as illustrated on the exemplary FIG. 13). According to yet another variant, some non-nearest spatial neighboring blocks while within a predefined searching region are considered as the reference block for spatial LIC parameters estimation for intra/inter prediction. In this case, a spatial LIC searching vector to indicate the displacement from the current block to a spatial reference block, is signaled into the bitstream.

### Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

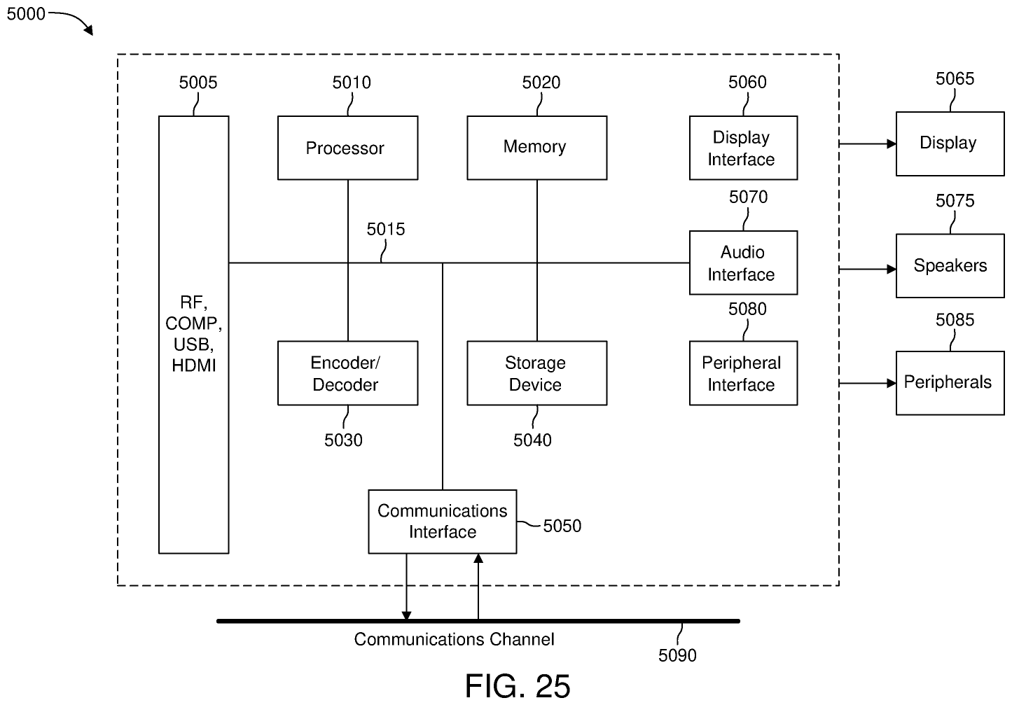

The aspects described and contemplated in this application can be implemented in many different forms. FIG. 23, FIG. 24 and FIG. 25 below provide some embodiments, but other embodiments are contemplated and the discussion of FIG. 23, FIG. 24 and FIG. 25 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra and/or inter prediction modules (160, 170, 260, 275) of a video encoder 100 and decoder 200 as shown in FIG. 23 and FIG. 24. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the number of transforms, the number of transform level, the indices of transforms. The specific values are for example purposes and the aspects described are not limited to these specific values.

FIG. 23 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 24 illustrates a block diagram of a video decoder 200. In the decoder 200, a bitstream is decoded by the decoder elements as described below. Video decoder 200 generally performs a decoding pass reciprocal to the encoding pass as described in FIG. 24. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 25 illustrates a block diagram of an example of a system in which various aspects and embodiments are implemented. System 5000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 5000, singly or in combination, can be embodied in a single integrated circuit (IC), multiple ICs, and/or discrete components. For example, in at least one embodiment, the processing and encoder/decoder elements of system 5000 are distributed across multiple ICs and/or discrete components. In various embodiments, the system 5000 is communicatively coupled to one or more other systems, or other electronic devices, via, for example, a communications bus or through dedicated input and/or output ports. In various embodiments, the system 5000 is configured to implement one or more of the aspects described in this document.

The system 5000 includes at least one processor 5010 configured to execute instructions loaded therein for implementing, for example, the various aspects described in this document. Processor 5010 can include embedded memory, input output interface, and various other circuitries as known in the art. The system 5000 includes at least one memory 5020 (e.g., a volatile memory device, and/or a non-volatile memory device). System 5000 includes a storage device 5040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 5040 can include an internal storage device, an attached storage device (including detachable and non-detachable storage devices), and/or a network accessible storage device, as non-limiting examples.

System 5000 includes an encoder/decoder module 5030 configured, for example, to process data to provide an encoded video or decoded video, and the encoder/decoder module 5030 can include its own processor and memory. The encoder/decoder module 5030 represents module(s) that can be included in a device to perform the encoding and/or decoding functions. As is known, a device can include one or both of the encoding and decoding modules. Additionally, encoder/decoder module 5030 can be implemented as a separate element of system 5000 or can be incorporated within processor 5010 as a combination of hardware and software as known to those skilled in the art.

Program code to be loaded onto processor 5010 or encoder/decoder 5030 to perform the various aspects described in this document can be stored in storage device 5040 and subsequently loaded onto memory 5020 for execution by processor 5010. In accordance with various embodiments, one or more of processor 5010, memory 5020, storage device 5040, and encoder/decoder module 5030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 5010 and/or the encoder/decoder module 5030 is used to store instructions and to provide working memory for processing that is needed during encoding or decoding. In other embodiments, however, a memory external to the processing device (for example, the processing device can be either the processor 5010 or the encoder/decoder module 5030) is used for one or more of these functions. The external memory can be the memory 5020 and/or the storage device 5040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 5000 can be provided through various input devices as indicated in block 5005. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 25, include composite video.

In various embodiments, the input devices of block 5005 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 5000 to other electronic devices across USB and/or HDMI connections. It is to be understood that various aspects of input processing, for example, Reed-Solomon error correction, can be implemented, for example, within a separate input processing IC or within processor 5010 as necessary. Similarly, aspects of USB or HDMI interface processing can be implemented within separate interface ICs or within processor 5010 as necessary. The demodulated, error corrected, and demultiplexed stream is provided to various processing elements, including, for example, processor 5010, and encoder/decoder 5030 operating in combination with the memory and storage elements to process the data stream as necessary for presentation on an output device.

Various elements of system 5000 can be provided within an integrated housing, Within the integrated housing, the various elements can be interconnected and transmit data therebetween using suitable connection arrangement 5015, for example, an internal bus as known in the art, including the Inter-IC (12C) bus, wiring, and printed circuit boards.

The system 5000 includes communication interface 5050 that enables communication with other devices via communication channel 5090. The communication interface 5050 can include, but is not limited to, a transceiver configured to transmit and to receive data over communication channel 5090. The communication interface 5050 can include, but is not limited to, a modem or network card and the communication channel 5090 can be implemented, for example, within a wired and/or a wireless medium.

Data is streamed, or otherwise provided, to the system 5000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 5090 and the communications interface 5050 which are adapted for Wi-Fi communications. The communications channel 5090 of these embodiments is typically connected to an access point or router that provides access to external networks including the Internet for allowing streaming applications and other over-the-top communications. Other embodiments provide streamed data to the system 5000 using a set-top box that delivers the data over the HDMI connection of the input block 5005. Still other embodiments provide streamed data to the system 5000 using the RF connection of the input block 5005. As indicated above, various embodiments provide data in a non-streaming manner. Additionally, various embodiments use wireless networks other than Wi-Fi, for example a cellular network or a Bluetooth network.

The system 5000 can provide an output signal to various output devices, including a display 5065, speakers 5075, and other peripheral devices 5085. The display 5065 of various embodiments includes one or more of, for example, a touchscreen display, an organic light-emitting diode (OLED) display, a curved display, and/or a foldable display. The display 5065 can be for a television, a tablet, a laptop, a cell phone (mobile phone), or other device. The display 5065 can also be integrated with other components (for example, as in a smart phone), or separate (for example, an external monitor for a laptop). The other peripheral devices 5085 include, in various examples of embodiments, one or more of a stand-alone digital video disc (or digital versatile disc) (DVR, for both terms), a disk player, a stereo system, and/or a lighting system. Various embodiments use one or more peripheral devices 5085 that provide a function based on the output of the system 5000. For example, a disk player performs the function of playing the output of the system 5000.

In various embodiments, control signals are communicated between the system 5000 and the display 5065, speakers 5075, or other peripheral devices 5085 using signaling such as AV.Link, Consumer Electronics Control (CEC), or other communications protocols that enable device-to-device control with or without user intervention. The output devices can be communicatively coupled to system 5000 via dedicated connections through respective interfaces 5065, 5075, and 5085. Alternatively, the output devices can be connected to system 5000 using the communications channel 5090 via the communications interface 5050. The display 5065 and speakers 5075 can be integrated in a single unit with the other components of system 5000 in an electronic device such as, for example, a television. In various embodiments, the display interface 5065 includes a display driver, such as, for example, a timing controller (T Con) chip.

The display 5065 and speaker 5075 can alternatively be separate from one or more of the other components, for example, if the RF portion of input 5005 is part of a separate set-top box. In various embodiments in which the display 5065 and speakers 5075 are external components, the output signal can be provided via dedicated output connections, including, for example, HDMI ports, USB ports, or COMP outputs.

The embodiments can be carried out by computer software implemented by the processor 5010 or by hardware, or by a combination of hardware and software. As a non-limiting example, the embodiments can be implemented by one or more integrated circuits. The memory 5020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 5010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, comprising deriving parameters of a spatial LIC and applying a spatial LIC to any of an inter prediction, intra prediction or IBC prediction.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, deriving parameters of a spatial LIC and applying a spatial LIC to any of an inter prediction, intra prediction or IBC prediction.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, for example, spatial_lic_flag, lic_refblk_index, lic_mrl_flag are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for transform. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into:
SDP (session description protocol), a format for describing multimedia communication sessions for the purposes of session announcement and session invitation, for example as described in RFCs and used in conjunction with RTP (Real-time Transport Protocol) transmission.
DASH MPD (Media Presentation Description) Descriptors, for example as used in DASH and transmitted over HTTP, a Descriptor is associated to a Representation or collection of Representations to provide additional characteristic to the content Representation.
RTP header extensions, for example as used during RTP streaming, and/or
ISO Base Media File Format, for example as used in OMAF and using boxes which are object-oriented building blocks defined by a unique type identifier and length also known as ‘atoms’ in some specifications.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Apply spatial local illumination compensation for inter/intra/IBC prediction in the decoder and/or encoder to compensate illumination discrepancy between different blocks in the same picture:
   a CU-level spatial LIC flag spatial_lic_flag is defined for an inter/intra/IBC block to indicate whether spatial LIC applies on the block or not;
   when the spatial LIC applies (spatial_lic_flag is true) for an inter/intra/IBC block, it uses a liner model for spatial illumination changes, using a scaling factor α and an offset β;
   the estimation of the spatial LIC parameters is derived by minimizing the difference between the neighboring reconstructed samples of the current block (current template) and the corresponding neighboring reconstructed samples of the spatial reference block (reference template) inside the same picture;
   apply the spatial LIC parameters on the inter/intra/IBC prediction samples to obtain the final prediction samples.
Derive a CU-level spatial LIC flag spatial_lic_flag in the decoder and/or encoder:
   for an inter block, the spatial LIC flag is copied from neighboring blocks if it is coded with merge mode, in a way similar to motion information copy in merge mode; otherwise, the spatial LIC flag is signaled;
   for an intra/IBC block, the spatial LIC flag is signaled;
   for an intra block, the spatial LIC flag is only presented for some intra prediction modes (i.e. DC and planar modes);
Select a spatial neighboring block used as the reference block for spatial LIC parameters estimation in the decoder and/or encoder:
   for an inter/intra block, the nearest reconstructed spatial neighboring block is selected as the reference block;
   only consider the available two nearest spatial neighboring blocks (above and left);
   if both above and left spatial neighboring blocks are available, they could be both applied as the reference blocks;
   if both above and left spatial neighboring blocks are available, and only one reference block is applied, add a flag lic_refblk_flag to indicate which one is applied;
   only consider the available five nearest spatial neighboring blocks (above/left/above-right/bottom-left/above-left);
   if all these five spatial neighboring blocks are available, and only one reference block is applied, add a flag lic_refblk_index to indicate which one is applied;
   for an inter block, once one of the five spatial candidates is selected as best MVP candidate, the block where the selected spatial MVP candidate located is select as the reference block;
   for an intra block, the reference block selection is based on the intra prediction mode;
   consider some non-nearest spatial neighboring blocks while within a predefined searching region, a spatial LIC searching vector to indicate the displacement from the current block to a spatial reference block, is signaled into the bitstream;
   for an IBC block, the reference block used for intra copy is selected as the reference block.
Generate the template, which is composed by the neighboring reconstructed samples, for spatial LIC parameters estimation in the decoder and/or encoder:
   for an inter/intra/IBC block, the template is composed by the neighboring reconstructed samples located in the left and above boundaries of the current/reference block;
   for an inter/intra/IBC block, the template is composed by the neighboring reconstructed samples located in multi left and above reference lines of the current/reference block;
   for an inter/intra/IBC block, the template is composed by the neighboring reconstructed samples located in multi left and above reference lines of the current/reference block;
   for an intra block, the template is composed by the whole neighboring reconstructed blocks of the current/reference block.
Signaling an information relative to spatial LIC process to apply in the decoder.
Deriving an information relative to a spatial LIC process to apply from a template, the deriving being applied in the decoder and/or encoder.
Inserting in the signaling syntax elements that enable the decoder to identify the spatial LIC process to use, such as transform indices.
Selecting, based on these syntax elements, the at least one spatial LIC process to apply at the decoder.
Applying the modified spatial LIC for deriving the at least one prediction at the decoder.
A bitstream or signal that includes one or more of the described syntax elements, or variations thereof.
A bitstream or signal that includes syntax conveying information generated according to any of the embodiments described.
Inserting in the signaling syntax elements that enable the decoder to apply spatial LIC process in a manner corresponding to that used by an encoder.
Creating and/or transmitting and/or receiving and/or decoding a bitstream or signal that includes one or more of the described syntax elements, or variations thereof.
and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs a spatial LIC process adapted to modify prediction according to any of the embodiments described.
A TV, set-top box, cell phone, tablet, or other electronic device that performs a spatial LIC process adapted to modify a prediction according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs a spatial LIC process adapted to modify a prediction according to any of the embodiments described.
A TV, set-top box, cell phone, tablet, or other electronic device that receives (e.g. using an antenna) a signal over the air that includes an encoded image, and performs a spatial LIC process adapted to modify a prediction according to any of the embodiments described.

1. A method for video decoding, comprising:
obtaining, for a current block in a picture, a prediction of the current block;
determining, for the current block, parameters for a local illumination compensation based on spatially neighboring reconstructed samples and corresponding spatially neighboring reconstructed samples of at least one spatial reference block;
decoding the current block by applying local illumination compensation to the prediction of the current block based on the determined parameters;
wherein the at least one spatial reference block is a spatially neighboring block of the current block in a same picture.

2-4. (canceled)

5. The method of claim 1, further comprising determining a syntax element indicating whether the local illumination compensation applies on the current block or not.

6. The method of claim 5, wherein the current block is coded in inter prediction.

7. The method of claim 6, wherein the at least one spatial reference block is any of an above adjacent neighboring block and a left adjacent neighboring block.

8. The method of claim 6, wherein the at least one spatial reference block is any of an above adjacent neighboring block, a left adjacent neighboring block, an above-right adjacent neighboring block, a bottom-left adjacent neighboring block and an above-left adjacent neighboring block.

9. The method of claim 6, wherein the at least one spatial reference block is a neighboring block selected as motion vector predictor MVP candidate.

10. The method of claim 5, wherein the current block is coded in intra prediction.

11-12. (canceled)

13. The method of claim 10, wherein the at least one spatial reference block is an adjacent neighboring block responsive to an intra prediction mode used to code the current block.

14. The method of claim 5, wherein the current block is coded in intra block copy prediction.

15. The method of claim 14, wherein the at least one spatial reference block comprises the neighboring block selected as intra block copy reference block.

16-26. (canceled)

27. A method comprising video encoding, comprising:
obtaining, for a current block in a picture, a prediction of the current block;
determining, for the current block, parameters for a local illumination compensation based on spatially neighboring reconstructed samples of the current block and corresponding spatially neighboring reconstructed samples of at least one spatial reference block;
encoding the current block by applying local illumination compensation to the prediction of the current block based on the determined parameters;
wherein the at least one spatial reference block is a spatially neighboring block of the current block in a same picture.

28. The method of claim 27, further comprising determining a syntax element indicating whether the local illumination compensation applies on the current block or not.

29. The method of claim 28, wherein the current block is coded in inter prediction.

30. The method of claim 29, wherein the at least one spatial reference block is any of an above adjacent neighboring block and a left adjacent neighboring block.

31. The method of claim 29, wherein the at least one spatial reference block is any of an above adjacent neighboring block, a left adjacent neighboring block, an above-right adjacent neighboring block, a bottom-left adjacent neighboring block and an above-left adjacent neighboring block.

32. The method of claim 29, wherein the at least one spatial reference block is a neighboring block selected as motion vector predictor MVP candidate.

33. The method of claim 28, wherein the current block is coded in intra prediction.

34. The method of claim 33, wherein the at least one spatial reference block is an adjacent neighboring block responsive to an intra prediction mode used to code the current block.

35. The method of claim 28, wherein the current block is coded in intra block copy prediction.

36. The method of claim 35, wherein the at least one spatial reference block comprises the neighboring block selected as intra block copy reference block.

37. An apparatus for video decoding, comprising one or more processors, and at least one memory and wherein the one or more processors is configured to:
obtain, for a current block in a picture, a prediction of the current block;
determine, for the current block, parameters for a local illumination compensation based on spatially neighboring reconstructed samples and corresponding spatially neighboring reconstructed samples of at least one spatial reference block;
decode the current block by applying local illumination compensation to the prediction of the current block based on the determined parameters;
wherein the at least one spatial reference block is a spatially neighboring block of the current block in a same picture.

38. An apparatus for video encoding, comprising one or more processors, and at least one memory and wherein the one or more processors is configured to:
obtain, for a current block in a picture, a prediction of the current block;
determine, for the current block, parameters for a local illumination compensation based on spatially neighboring reconstructed samples and corresponding spatially neighboring reconstructed samples of at least one spatial reference block;
encode the current block by applying local illumination compensation to the prediction of the current block based on the determined parameters;
wherein the at least one spatial reference block is a spatially neighboring block of the current block in a same picture.
